(19) United States
(12) Patent Application Publication
(10) Pub. No.: US 2020/0229135 A1
(43) Pub. Date: Jul. 16, 2020

(54) COORDINATION AND TRANSMISSION OF JOINT PAGING

(71) Applicant: QUALCOMM Incorporated, San Diego, CA (US)

(72) Inventors: Ozcan Ozturk, San Diego, CA (US); Heechoon Lee, San Diego, CA (US); Gavin Bernard Hom, La Jolla, CA (US); Tingfang Ji, San Diego, CA (US)

(21) Appl. No.: 16/741,511

(22) Filed: Jan. 13, 2020

Related U.S. Application Data
(60) Provisional application No. 62/792,351, filed on Jan. 14, 2019.

(51) Int. Cl. H04W 68/02; H04W 76/30; H04W 8/22

(52) U.S. Cl. CPC H04W 68/02; H04W 8/22; H04W 76/30

(57) ABSTRACT

Methods, systems, and devices for wireless communications are described. A wireless communications system may employ joint paging techniques. Multiple base stations may coordinate to determine joint paging parameters for a joint paging area. Each base station in the joint paging area may use the same paging parameters to generate the same joint paging message. The base stations in the joint paging area may communicate over backhaul links, such as an Xn interface. A user equipment (UE) in the joint paging area may be provided the joint paging parameters and monitor for paging messages based on the joint paging configuration. In some cases, the UE may be provided the joint paging parameters in a resource release message. Additionally, or alternatively, a base station of the joint paging area may broadcast the joint paging parameters.

### CROSS REFERENCE

The present application for patent claims the benefit of U.S. Provisional Patent Application No. 62/792,351 by OZTURK et al., entitled “COORDINATION AND TRANSMISSION OF JOINT PAGING,” filed Jan. 14, 2019, assigned to the assignee hereof, and expressly incorporated herein.

### BACKGROUND

The following relates generally to wireless communications, and more specifically to coordination and transmission of joint paging.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include a number of base stations or network access nodes, each simultaneously supporting communication for multiple communication devices, which may be otherwise known as user equipment (UE).

A UE may monitor for paging messages while in a low power, idle, or inactive state. When the UE has pending messages, a base station may transmit a paging message to the UE, which may initiate data transfer between the base station and the UE to relay the pending messages. The UE may periodically turn on its radio frequency capabilities to monitor for the paging messages according to a configuration for the paging. Conventional techniques to page a UE may use significant power at the UE and can be improved.

### SUMMARY

The described techniques relate to improved methods, systems, devices, and apparatuses that support coordination and transmission of joint paging. Generally, the described techniques provide for coordinating between multiple base stations to establish a joint paging area and joint paging configuration. A wireless communications system may include one or more user equipments (UEs) and multiple base stations. A UE may be configured to operate in one of multiple different states for a radio resource control (RRC) protocol, including an RRC connected mode, an idle mode, and an RRC inactive mode. To notify a UE which is in the RRC inactive or idle mode of pending data or control information, the base stations in the wireless communications system may transmit paging messages to the UE. In conventional systems, paging procedures at an idle mode or inactive mode UE can consume considerable power at the UE, as the UE may monitor for reference signals and paging messages according to multiple different paging configurations for each of the different base stations.

According to the joint paging techniques described herein, multiple cells may employ the same joint paging configuration to transmit the same paging message. In the joint paging scheme, multiple base stations can coordinate to determine the paging parameters and establish a joint paging configuration. Each joint paging area may be controlled, and in some cases set up, by a primary base station which decides the final parameters for the joint paging configuration. The base stations in the joint paging area may coordinate the joint paging parameters over backhaul links, such as over an Xn interface. The joint paging area parameters may be provided to the UE so that the UE can monitor for paging messages according to the configuration. In some cases, the joint paging parameters may be transmitted to the UE in an RRC release message or an RRC reconfiguration message. The base stations in the joint paging area may also be configured to broadcast the joint paging parameters. This may support the UE camping on any cell in the joint paging area without reading a system information block message from the selected cell. The UE may then employ the joint paging area configuration to monitor for joint paging messages from the base stations in the joint paging area.

A method of wireless communication by a UE is described. The method may include receiving one or more joint paging parameters for a joint paging area for idle mode paging, inactive mode paging, or both and monitoring, while in an inactive mode or an idle mode, for a joint paging message based on the one or more joint paging parameters.

An apparatus for wireless communication by a UE is described. The apparatus may include a processor, memory in electronic communication with the processor, and instructions stored in the memory. The instructions may be executable by the processor to cause the apparatus to receive one or more joint paging parameters for a joint paging area for idle mode paging, inactive mode paging, or both and monitor, while in an inactive mode or an idle mode, for a joint paging message based on the one or more joint paging parameters.

Another apparatus for wireless communication by a UE is described. The apparatus may include means for receiving one or more joint paging parameters for a joint paging area for idle mode paging, inactive mode paging, or both and monitoring, while in an inactive mode or an idle mode, for a joint paging message based on the one or more joint paging parameters.

A non-transitory computer-readable medium storing code for wireless communication by a UE is described. The code may include instructions executable by a processor to receive one or more joint paging parameters for a joint paging area for idle mode paging, inactive mode paging, or both and monitor, while in an inactive mode or an idle mode, for a joint paging message based on the one or more joint paging parameters.

In some examples of the method, apparatuses, and non-transitory computer-readable medium described herein, receiving the one or more joint paging parameters for the joint paging area further may include operations, features, means, or instructions for receiving a radio resource reconfiguration message or a radio resource release message that includes the one or more joint paging parameters.

In some examples of the method, apparatuses, and non-transitory computer-readable medium described herein, the one or more joint paging parameters include one or more of a default paging cycle, a number of paging occasions per cycle, an offset for a paging frame, one or more offsets for each paging occasion, a paging search space, one or more physical channel parameters, or any combination thereof.

In some examples of the method, apparatuses, and non-transitory computer-readable medium described herein, monitoring for the joint paging message further may include operations, features, means, or instructions for receiving the joint paging message, and transmitting a paging response based on the joint paging message.

Some examples of the method, apparatuses, and non-transitory computer-readable medium described herein may further include operations, features, means, or instructions for receiving an update to one or more of the one or more joint paging parameters, and monitoring for the joint paging message in accordance with the updated one or more joint paging parameters.

In some examples of the method, apparatuses, and non-transitory computer-readable medium described herein, the updated one or more joint paging parameters may be an update to a cell barring parameter, a camping parameter, or both for a base station associated with the joint paging area.

Some examples of the method, apparatuses, and non-transitory computer-readable medium described herein may further include operations, features, means, or instructions for receiving an identifier of the base station associated with the joint paging area having the updated one or more joint paging parameters.

In some examples of the method, apparatuses, and non-transitory computer-readable medium described herein, the identifier may be an index or a bitmap.

Some examples of the method, apparatuses, and non-transitory computer-readable medium described herein may further include operations, features, means, or instructions for identifying that the UE may have moved from the joint paging area to a second joint paging area, identifying one or more second joint paging parameters for the second joint paging area for idle mode paging, inactive mode paging, or both, and monitoring for a second joint paging message in accordance with the one or more second joint paging parameters based on the UE operating in an inactive mode or an idle mode.

Some examples of the method, apparatuses, and non-transitory computer-readable medium described herein may further include operations, features, means, or instructions for receiving one or more joint paging parameters for a second joint paging area that differs from the joint paging area, and monitoring for a second joint paging message based on the one or more joint paging parameters for the second joint paging area.

Some examples of the method, apparatuses, and non-transitory computer-readable medium described herein may further include operations, features, means, or instructions for transmitting a capability message indicating a capability of the UE to receive joint paging, and receiving the joint paging message based on the capability message.

In some examples of the method, apparatuses, and non-transitory computer-readable medium described herein, the joint paging message indicates that the joint paging message may be initiated from a core network or a radio access network.

In some examples of the method, apparatuses, and non-transitory computer-readable medium described herein, monitoring for the joint paging message further may include operations, features, means, or instructions for monitoring for the joint paging message from a first base station and a second base station, where the first base station may be a primary base station and the second base station may be a secondary base station.

In some examples of the method, apparatuses, and non-transitory computer-readable medium described herein, monitoring for the joint paging message further may include operations, features, means, or instructions for monitoring for the joint paging message from a first base station and a second base station, where the first base station may be a secondary base station and the second base station may be a primary base station.

In some examples of the method, apparatuses, and non-transitory computer-readable medium described herein, monitoring for the joint paging message further may include operations, features, means, or instructions for determining a paging frame and a paging occasion based on the one or more joint paging parameters, and monitoring for the joint paging message based on the paging frame and the paging occasion.

A method of wireless communication by a first base station is described. The method may include coordinating with a second base station to define a configuration for a joint paging area for idle mode paging, inactive mode paging, or both, identifying a UE within the joint paging area that is operating in an inactive mode or an idle mode, and transmitting a joint paging message to the UE in accordance with the configuration.

An apparatus for wireless communication by a first base station is described. The apparatus may include a processor, memory in electronic communication with the processor, and instructions stored in the memory. The instructions may be executable by the processor to cause the apparatus to coordinate with a second base station to define a configuration for a joint paging area for idle mode paging, inactive mode paging, or both, identify a UE within the joint paging area that is operating in an inactive mode or an idle mode, and transmit a joint paging message to the UE in accordance with the configuration.

Another apparatus for wireless communication by a first base station is described. The apparatus may include means for coordinating with a second base station to define a configuration for a joint paging area for idle mode paging, inactive mode paging, or both, identifying a UE within the joint paging area that is operating in an inactive mode or an idle mode, and transmitting a joint paging message to the UE in accordance with the configuration.

A non-transitory computer-readable medium storing code for wireless communication by a first base station is described. The code may include instructions executable by a processor to coordinate with a second base station to define a configuration for a joint paging area for idle mode paging, inactive mode paging, or both, identify a UE within the joint paging area that is operating in an inactive mode or an idle mode, and transmit a joint paging message to the UE in accordance with the configuration.

In some examples of the method, apparatuses, and non-transitory computer-readable medium described herein, coordinating with the second base station to define the configuration further may include operations, features, means, or instructions for exchanging capability information, channel configuration, or both, with the second base station.

In some examples of the method, apparatuses, and non-transitory computer-readable medium described herein, coordinating with the second base station to define the configuration further may include operations, features, means, or instructions for indicating one or more joint paging parameters for the joint paging area.

In some examples of the method, apparatuses, and non-transitory computer-readable medium described herein, coordinating with the second base station to define the configuration further may include operations, features, means, or instructions for receiving a suggested modification to at least one of the one or more joint paging parameters.

In some examples of the method, apparatuses, and non-transitory computer-readable medium described herein, coordinating with the second base station to define the configuration further may include operations, features, means, or instructions for transmitting the configuration to the second base station.

In some examples of the method, apparatuses, and non-transitory computer-readable medium described herein, the first base station belongs to a set of joint paging areas that includes the joint paging area.

In some examples of the method, apparatuses, and non-transitory computer-readable medium described herein, a paging occasion of the joint paging area differs in time, frequency, or both, from a paging occasion of a second joint paging area of the set of joint paging areas.

Some examples of the method, apparatuses, and non-transitory computer-readable medium described herein may further include operations, features, means, or instructions for transmitting one or more joint paging parameters for the joint paging area that correspond to the configuration.

In some examples of the method, apparatuses, and non-transitory computer-readable medium described herein, transmitting the one or more joint paging parameters further may include operations, features, means, or instructions for broadcasting the one or more joint paging parameters.

In some examples of the method, apparatuses, and non-transitory computer-readable medium described herein, transmitting the one or more joint paging parameters further may include operations, features, means, or instructions for transmitting, to the UE, a radio resource control release message or a radio resource reconfiguration message that includes the one or more joint paging parameters.

In some examples of the method, apparatuses, and non-transitory computer-readable medium described herein, the one or more joint paging parameters include one or more of a default paging cycle, a number of paging occasions per cycle, an offset for a paging frame, one or more offsets for each paging occasion, a paging search space, one or more physical channel parameters, or any combination thereof.

In some examples of the method, apparatuses, and non-transitory computer-readable medium described herein, the first and second base stations belong to the joint paging area and each use the one or more joint paging parameters for idle mode paging, inactive mode paging, or both.

Some examples of the method, apparatuses, and non-transitory computer-readable medium described herein may further include operations, features, means, or instructions for broadcasting one or more joint paging parameters for the second base station and an identifier for the second base station.

Some examples of the method, apparatuses, and non-transitory computer-readable medium described herein may further include operations, features, means, or instructions for updating the configuration for the joint paging area, and transmitting the updated configuration.

In some examples of the method, apparatuses, and non-transitory computer-readable medium described herein, updating the configuration further may include operations, features, means, or instructions for updating a cell barring parameter, a camping parameter, or both for a base station associated with the joint paging area.

In some examples of the method, apparatuses, and non-transitory computer-readable medium described herein, transmitting the updated configuration may include operations, features, means, or instructions for transmitting an identifier of the base station associated with the joint paging area corresponding to the updated cell barring parameter, the updated camping parameter, or both.

In some examples of the method, apparatuses, and non-transitory computer-readable medium described herein, the identifier may be an index or a bitmap.

Some examples of the method, apparatuses, and non-transitory computer-readable medium described herein may further include operations, features, means, or instructions for coordinating with a third base station to define a second configuration for a second joint paging area for idle mode paging, inactive mode paging, or both, and transmitting one or more joint paging parameters for the second joint paging area that correspond to the second configuration.

Some examples of the method, apparatuses, and non-transitory computer-readable medium described herein may further include operations, features, means, or instructions for receiving a capability message from the UE indicating a capability of the UE to receive joint paging, where the joint paging message may be transmitted to the UE based on the capability message.

In some examples of the method, apparatuses, and non-transitory computer-readable medium described herein, the joint paging message indicates that the joint paging message may be initiated from a core network or a radio access network.

In some examples of the method, apparatuses, and non-transitory computer-readable medium described herein, the first base station may be a primary base station and the second base station may be a secondary base station.

In some examples of the method, apparatuses, and non-transitory computer-readable medium described herein, the first base station may be a secondary base station and the second base station may be a primary base station.

### BRIEF DESCRIPTION OF THE DRAWINGS

FIG. 1 illustrates an example of a system for wireless communications that supports coordination and transmission of joint paging in accordance with aspects of the present disclosure.

FIGS. 2 and 3 illustrate examples of wireless communications systems that support coordination and transmission of joint paging in accordance with aspects of the present disclosure.

FIGS. 4 and 5 illustrate examples of process flow diagrams that support coordination and transmission of joint paging in accordance with aspects of the present disclosure.

FIGS. 6 and 7 show block diagrams of devices that support coordination and transmission of joint paging in accordance with aspects of the present disclosure.

FIG. 8 shows a block diagram of a communications manager that supports coordination and transmission of joint paging in accordance with aspects of the present disclosure.

FIG. 9 shows a diagram of a system including a device that supports coordination and transmission of joint paging in accordance with aspects of the present disclosure.

FIGS. 10 and 11 show block diagrams of devices that support coordination and transmission of joint paging in accordance with aspects of the present disclosure.

FIG. 12 shows a block diagram of a communications manager that supports coordination and transmission of joint paging in accordance with aspects of the present disclosure.

FIG. 13 shows a diagram of a system including a device that supports coordination and transmission of joint paging in accordance with aspects of the present disclosure.

FIGS. 14 through 18 show flowcharts illustrating methods that support coordination and transmission of joint paging in accordance with aspects of the present disclosure.

### DETAILED DESCRIPTION

A wireless communications system may include one or more user equipments (UEs) and one or more base stations. A UE may be configured to operate in one of multiple different states for a radio resource control (RRC) protocol, including an RRC connected mode, an idle mode, and an RRC inactive mode. In the RRC connected state, the UE and a serving base station may have an established connection to communicate data and control information. In the idle mode, the UE may not have an RRC connection established with a base station, and the UE may often be in a low power or sleep mode to conserve power. The UE may also be configured to use an RRC inactive mode, which is similar to the idle mode, but the RRC context may still be stored in at least one of the base stations. By maintaining the RRC context for the UE in the RRC inactive mode, the UE may be able to quickly transition back to communicate data when the RRC connection is resumed.

To notify a UE which is in the RRC inactive or idle mode of pending data or control information, the base stations in the wireless communications system may transmit paging messages to the UE. In conventional systems, paging procedures at the UE in idle or inactive mode can consume considerable power at the UE, as the UE may monitor for reference signals and paging messages at different times. For example, the base stations may use beamformed transmissions to transmit paging messages in different directions at different times, and each base station may have a different paging configuration, which may correspond to different beams, paging occasions, and paging frames which the UE would monitor to receive the paging message. While the UE may enter the RRC inactive or idle mode to conserve power, the UE-side paging procedures may be inefficient at managing power usage, as the UE regularly powers on its radio frequency capabilities to monitor for paging messages according to multiple different configurations.

To improve UE-side power conservations for paging techniques, the wireless communications system may implement joint paging techniques for a joint paging area. According to the described joint paging techniques, multiple cells can transmit the same paging message. In the joint paging scheme, multiple base stations can coordinate paging parameters to establish a joint paging configuration. Multiple base stations which use the same paging parameters may form a joint paging area, where each base station in the joint paging area uses the same paging parameters to transmit the same paging message. Each joint paging area may be controlled by a primary base station which determines the actual parameters for the joint paging area configuration, for example after coordinating with one or more other base stations (e.g., secondary base stations to the primary base station). The base stations in the joint paging area may coordinate the joint paging parameters over Xn connections or some other example of a lossless or near lossless interface for communication between one or more base stations.

The joint paging area parameters may be provided to the UE so that the UE can monitor for paging messages according to the configuration. In some cases, the joint paging parameters may be transmitted to the UE in an RRC release message, such as when the UE transitions from the RRC connected mode to the RRC inactive or idle mode. The base stations in the joint paging area may also be configured to broadcast the joint paging parameters. For example, a base station in a joint paging area may broadcast paging parameters for other cells in the joint paging area. This may support the UE to defer reading a system information block 1 (SIB1) when moving to another cell in the joint paging area. In some cases, the UE may be provided cell selection and cell barring parameters or any updates to the cell selection or cell barring parameters. The cell camping and cell barring parameters may also be provided in an RRC release message or be broadcasted by a base station (e.g., if the UE moves to a base station which was not included in the RRC release message). The UE may then camp on a cell in the joint paging area without reading a SIB1 message from the selected cell. The UE may then employ the joint paging area configuration to monitor for joint paging messages from the base stations in the joint paging area.

Aspects of the disclosure are initially described in the context of a wireless communications system. Aspects of the disclosure are further illustrated by and described with reference to apparatus diagrams, system diagrams, and flowcharts that relate to coordination and transmission of joint paging.

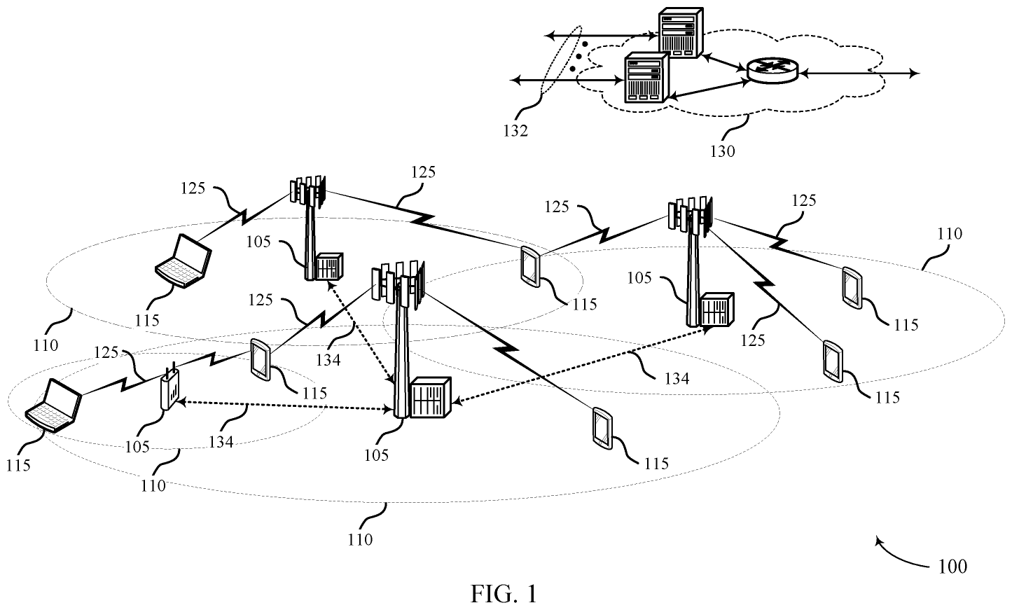

FIG. 1 illustrates an example of a wireless communications system 100 that supports coordination and transmission of joint paging in accordance with aspects of the present disclosure. The wireless communications system 100 includes base stations 105, UEs 115, and a core network 130. In some examples, the wireless communications system 100 may be a Long Term Evolution (LTE) network, an LTE-Advanced (LTE-A) network, an LTE-A Pro network, or a New Radio (NR) network. In some cases, wireless communications system 100 may support enhanced broadband communications, ultra-reliable (e.g., mission critical) communications, low latency communications, or communications with low-cost and low-complexity devices.

Base stations 105 may wirelessly communicate with UEs 115 via one or more base station antennas. Base stations 105 described herein may include or may be referred to by those skilled in the art as a base transceiver station, a radio base station, an access point, a radio transceiver, a NodeB, an eNodeB (eNB), a next-generation NodeB or giga-NodeB (either of which may be referred to as a gNB), a Home NodeB, a Home eNodeB, or some other suitable terminology. Wireless communications system 100 may include base stations 105 of different types (e.g., macro or small cell base stations). The UEs 115 described herein may be able to communicate with various types of base stations 105 and network equipment including macro eNBs, small cell eNBs, gNBs, relay base stations, and the like.

Each base station 105 may be associated with a particular geographic coverage area 110 in which communications with various UEs 115 is supported. Each base station 105 may provide communication coverage for a respective geographic coverage area 110 via communication links 125, and communication links 125 between a base station 105 and a UE 115 may utilize one or more carriers. Communication links 125 shown in wireless communications system 100 may include uplink transmissions from a UE 115 to a base station 105, or downlink transmissions from a base station 105 to a UE 115. Downlink transmissions may also be called forward link transmissions while uplink transmissions may also be called reverse link transmissions.

The geographic coverage area 110 for a base station 105 may be divided into sectors making up a portion of the geographic coverage area 110, and each sector may be associated with a cell. For example, each base station 105 may provide communication coverage for a macro cell, a small cell, a hot spot, or other types of cells, or various combinations thereof. In some examples, a base station 105 may be movable and therefore provide communication coverage for a moving geographic coverage area 110. In some examples, different geographic coverage areas 110 associated with different technologies may overlap, and overlapping geographic coverage areas 110 associated with different technologies may be supported by the same base station 105 or by different base stations 105. The wireless communications system 100 may include, for example, a heterogeneous LTE/LTE-A/LTE-A Pro or NR network in which different types of base stations 105 provide coverage for various geographic coverage areas 110.

The term “cell” refers to a logical communication entity used for communication with a base station 105 (e.g., over a carrier), and may be associated with an identifier for distinguishing neighboring cells (e.g., a physical cell identifier (PCID), a virtual cell identifier (VCID)) operating via the same or a different carrier. In some examples, a carrier may support multiple cells, and different cells may be configured according to different protocol types (e.g., machine-type communication (MTC), narrowband Internet-of-Things (NB-IoT), enhanced mobile broadband (eMBB), or others) that may provide access for different types of devices. In some cases, the term “cell” may refer to a portion of a geographic coverage area 110 (e.g., a sector) over which the logical entity operates.

UEs 115 may be dispersed throughout the wireless communications system 100, and each UE 115 may be stationary or mobile. A UE 115 may also be referred to as a mobile device, a wireless device, a remote device, a handheld device, or a subscriber device, or some other suitable terminology, where the “device” may also be referred to as a unit, a station, a terminal, or a client. A UE 115 may also be a personal electronic device such as a cellular phone, a personal digital assistant (PDA), a tablet computer, a laptop computer, or a personal computer. In some examples, a UE 115 may also refer to a wireless local loop (WLL) station, an Internet of Things (IoT) device, an Internet of Everything (IoE) device, or an MTC device, or the like, which may be implemented in various articles such as appliances, vehicles, meters, or the like.

Some UEs 115, such as MTC or IoT devices, may be low cost or low complexity devices, and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay that information to a central server or application program that can make use of the information or present the information to humans interacting with the program or application. Some UEs 115 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples half-duplex communications may be performed at a reduced peak rate. Other power conservation techniques for UEs 115 include entering a power saving “deep sleep” mode when not engaging in active communications, or operating over a limited bandwidth (e.g., according to narrowband communications). In some cases, UEs 115 may be designed to support critical functions (e.g., mission critical functions), and a wireless communications system 100 may be configured to provide ultra-reliable communications for these functions.

In some cases, a UE 115 may also be able to communicate directly with other UEs 115 (e.g., using a peer-to-peer (P2P) or device-to-device (D2D) protocol). One or more of a group of UEs 115 utilizing D2D communications may be within the geographic coverage area 110 of a base station 105. Other UEs 115 in such a group may be outside the geographic coverage area 110 of a base station 105, or be otherwise unable to receive transmissions from a base station 105. In some cases, groups of UEs 115 communicating via D2D communications may utilize a one-to-many (1:M) system in which each UE 115 transmits to every other UE 115 in the group. In some cases, a base station 105 facilitates the scheduling of resources for D2D communications. In other cases, D2D communications are carried out between UEs 115 without the involvement of a base station 105.

Base stations 105 may communicate with the core network 130 and with one another. For example, base stations 105 may interface with the core network 130 through backhaul links 132 (e.g., via an S1, N2, N3, or other interface). Base stations 105 may communicate with one another over backhaul links 134 (e.g., via an X2, Xn, or other interface) either directly (e.g., directly between base stations 105) or indirectly (e.g., via core network 130).

The core network 130 may provide user authentication, access authorization, tracking, Internet Protocol (IP) connectivity, and other access, routing, or mobility functions. The core network 130 may be an evolved packet core (EPC), which may include at least one mobility management entity (MME), at least one serving gateway (S-GW), and at least one Packet Data Network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP Multimedia Subsystem (IMS), or a Packet-Switched (PS) Streaming Service.

At least some of the network devices, such as a base station 105, may include subcomponents such as an access network entity, which may be an example of an access node controller (ANC). Each access network entity may communicate with UEs 115 through a number of other access network transmission entities, which may be referred to as a radio head, a smart radio head, or a transmission/reception point (TRP). In some configurations, various functions of each access network entity or base station 105 may be distributed across various network devices (e.g., radio heads and access network controllers) or consolidated into a single network device (e.g., a base station 105).

Wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band, since the wavelengths range from approximately one decimeter to one meter in length. UHF waves may be blocked or redirected by buildings and environmental features. However, the waves may penetrate structures sufficiently for a macro cell to provide service to UEs 115 located indoors. Transmission of UHF waves may be associated with smaller antennas and shorter range (e.g., less than 100 km) compared to transmission using the smaller frequencies and longer waves of the high frequency (HF) or very high frequency (VHF) portion of the spectrum below 300 MHz.

Wireless communications system 100 may also operate in a super high frequency (SHF) region using frequency bands from 3 GHz to 30 GHz, also known as the centimeter band. The SHF region includes bands such as the 5 GHz industrial, scientific, and medical (ISM) bands, which may be used opportunistically by devices that may be capable of tolerating interference from other users.

Wireless communications system 100 may also operate in an extremely high frequency (EHF) region of the spectrum (e.g., from 30 GHz to 300 GHz), also known as the millimeter band. In some examples, wireless communications system 100 may support millimeter wave (mmW) communications between UEs 115 and base stations 105, and EHF antennas of the respective devices may be even smaller and more closely spaced than UHF antennas. In some cases, this may facilitate use of antenna arrays within a UE 115. However, the propagation of EHF transmissions may be subject to even greater atmospheric attenuation and shorter range than SHF or UHF transmissions. Techniques disclosed herein may be employed across transmissions that use one or more different frequency regions, and designated use of bands across these frequency regions may differ by country or regulating body.

In some cases, wireless communications system 100 may utilize both licensed and unlicensed radio frequency spectrum bands. For example, wireless communications system 100 may employ License Assisted Access (LAA), LTE-Unlicensed (LTE-U) radio access technology, or NR technology in an unlicensed band such as the 5 GHz ISM band. When operating in unlicensed radio frequency spectrum bands, wireless devices such as base stations 105 and UEs 115 may employ listen-before-talk (LBT) procedures to ensure a frequency channel is clear before transmitting data. In some cases, operations in unlicensed bands may be based on a carrier aggregation configuration in conjunction with component carriers operating in a licensed band (e.g., LAA). Operations in unlicensed spectrum may include downlink transmissions, uplink transmissions, peer-to-peer transmissions, or a combination of these. Duplexing in unlicensed spectrum may be based on frequency division duplexing (FDD), time division duplexing (TDD), or a combination of both.

In some examples, base station 105 or UE 115 may be equipped with multiple antennas, which may be used to employ techniques such as transmit diversity, receive diversity, multiple-input multiple-output (MIMO) communications, or beamforming. For example, wireless communications system 100 may use a transmission scheme between a transmitting device (e.g., a base station 105) and a receiving device (e.g., a UE 115), where the transmitting device is equipped with multiple antennas and the receiving device is equipped with one or more antennas. MIMO communications may employ multipath signal propagation to increase the spectral efficiency by transmitting or receiving multiple signals via different spatial layers, which may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream, and may carry bits associated with the same data stream (e.g., the same codeword) or different data streams. Different spatial layers may be associated with different antenna ports used for channel measurement and reporting. MIMO techniques include single-user MIMO (SU-MIMO) where multiple spatial layers are transmitted to the same receiving device, and multiple-user MIMO (MU-MIMO) where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105 or a UE 115) to shape or steer an antenna beam (e.g., a transmit beam or receive beam) along a spatial path between the transmitting device and the receiving device. Beamforming may be achieved by combining the signals communicated via antenna elements of an antenna array such that signals propagating at particular orientations with respect to an antenna array experience constructive interference while others experience destructive interference. The adjustment of signals communicated via the antenna elements may include a transmitting device or a receiving device applying certain amplitude and phase offsets to signals carried via each of the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In one example, a base station 105 may use multiple antennas or antenna arrays to conduct beamforming operations for directional communications with a UE 115. For instance, some signals (e.g. synchronization signals, reference signals, beam selection signals, or other control signals) may be transmitted by a base station 105 multiple times in different directions, which may include a signal being transmitted according to different beamforming weight sets associated with different directions of transmission. Transmissions in different beam directions may be used to identify (e.g., by the base station 105 or a receiving device, such as a UE 115) a beam direction for subsequent transmission and/or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based at least in in part on a signal that was transmitted in different beam directions. For example, a UE 115 may receive one or more of the signals transmitted by the base station 105 in different directions, and the UE 115 may report to the base station 105 an indication of the signal it received with a highest signal quality, or an otherwise acceptable signal quality. Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115), or transmitting a signal in a single direction (e.g., for transmitting data to a receiving device).

A receiving device (e.g., a UE 115, which may be an example of a mmW receiving device) may try multiple receive beams when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets applied to signals received at a plurality of antenna elements of an antenna array, or by processing received signals according to different receive beamforming weight sets applied to signals received at a plurality of antenna elements of an antenna array, any of which may be referred to as “listening” according to different receive beams or receive directions. In some examples a receiving device may use a single receive beam to receive along a single beam direction (e.g., when receiving a data signal). The single receive beam may be aligned in a beam direction determined based at least in part on listening according to different receive beam directions (e.g., a beam direction determined to have a highest signal strength, highest signal-to-noise ratio, or otherwise acceptable signal quality based at least in part on listening according to multiple beam directions).

In some cases, the antennas of a base station 105 or UE 115 may be located within one or more antenna arrays, which may support MIMO operations, or transmit or receive beamforming. For example, one or more base station antennas or antenna arrays may be co-located at an antenna assembly, such as an antenna tower. In some cases, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations.

In some cases, wireless communications system 100 may be a packet-based network that operate according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use hybrid automatic repeat request (HARD) to provide retransmission at the MAC layer to improve link efficiency. In the control plane, the Radio Resource Control (RRC) protocol layer may provide establishment, configuration, and maintenance of an RRC connection between a UE 115 and a base station 105 or core network 130 supporting radio bearers for user plane data. At the Physical layer, transport channels may be mapped to physical channels.

In some cases, UEs 115 and base stations 105 may support retransmissions of data to increase the likelihood that data is received successfully. HARQ feedback is one technique of increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., signal-to-noise conditions). In some cases, a wireless device may support same-slot HARQ feedback, where the device may provide HARQ feedback in a specific slot for data received in a previous symbol in the slot. In other cases, the device may provide HARQ feedback in a subsequent slot, or according to some other time interval.

Time intervals in LTE or NR may be expressed in multiples of a basic time unit, which may, for example, refer to a sampling period of Tₛ=1/30,720,000 seconds. Time intervals of a communications resource may be organized according to radio frames each having a duration of 10 milliseconds (ms), where the frame period may be expressed as T_{f}=307,200 Tₛ. The radio frames may be identified by a system frame number (SFN) ranging from 0 to 1023. Each frame may include 10 subframes numbered from 0 to 9, and each subframe may have a duration of 1 ms. A subframe may be further divided into 2 slots each having a duration of 0.5 ms, and each slot may contain 6 or 7 modulation symbol periods (e.g., depending on the length of the cyclic prefix prepended to each symbol period). Excluding the cyclic prefix, each symbol period may contain 2048 sampling periods. In some cases, a subframe may be the smallest scheduling unit of the wireless communications system 100, and may be referred to as a transmission time interval (TTI). In other cases, a smallest scheduling unit of the wireless communications system 100 may be shorter than a subframe or may be dynamically selected (e.g., in bursts of shortened TTIs (sTTIs) or in selected component carriers using sTTIs).

In some wireless communications systems, a slot may further be divided into multiple mini-slots containing one or more symbols. In some instances, a symbol of a mini-slot or a mini-slot may be the smallest unit of scheduling. Each symbol may vary in duration depending on the subcarrier spacing or frequency band of operation, for example. Further, some wireless communications systems may implement slot aggregation in which multiple slots or mini-slots are aggregated together and used for communication between a UE 115 and a base station 105.

The term “carrier” refers to a set of radio frequency spectrum resources having a defined physical layer structure for supporting communications over a communication link 125. For example, a carrier of a communication link 125 may include a portion of a radio frequency spectrum band that is operated according to physical layer channels for a given radio access technology. Each physical layer channel may carry user data, control information, or other signaling. A carrier may be associated with a pre-defined frequency channel (e.g., an evolved universal mobile telecommunication system terrestrial radio access (E-UTRA) absolute radio frequency channel number (EARFCN)), and may be positioned according to a channel raster for discovery by UEs 115. Carriers may be downlink or uplink (e.g., in an FDD mode), or be configured to carry downlink and uplink communications (e.g., in a TDD mode). In some examples, signal waveforms transmitted over a carrier may be made up of multiple sub-carriers (e.g., using multi-carrier modulation (MCM) techniques such as orthogonal frequency division multiplexing (OFDM) or discrete Fourier transform spread OFDM (DFT-S-OFDM)).

The organizational structure of the carriers may be different for different radio access technologies (e.g., LTE, LTE-A, LTE-A Pro, NR). For example, communications over a carrier may be organized according to TTIs or slots, each of which may include user data as well as control information or signaling to support decoding the user data. A carrier may also include dedicated acquisition signaling (e.g., synchronization signals or system information, etc.) and control signaling that coordinates operation for the carrier. In some examples (e.g., in a carrier aggregation configuration), a carrier may also have acquisition signaling or control signaling that coordinates operations for other carriers.

Physical channels may be multiplexed on a carrier according to various techniques. A physical control channel and a physical data channel may be multiplexed on a downlink carrier, for example, using time division multiplexing (TDM) techniques, frequency division multiplexing (FDM) techniques, or hybrid TDM-FDM techniques. In some examples, control information transmitted in a physical control channel may be distributed between different control regions in a cascaded manner (e.g., between a common control region or common search space and one or more UE-specific control regions or UE-specific search spaces).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of predetermined bandwidths for carriers of a particular radio access technology (e.g., 1.4, 3, 5, 10, 15, 20, 40, or 80 MHz). In some examples, each served UE 115 may be configured for operating over portions or all of the carrier bandwidth. In other examples, some UEs 115 may be configured for operation using a narrowband protocol type that is associated with a predefined portion or range (e.g., set of subcarriers or RBs) within a carrier (e.g., “in-band” deployment of a narrowband protocol type).

In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme). Thus, the more resource elements that a UE 115 receives and the higher the order of the modulation scheme, the higher the data rate may be for the UE 115. In MIMO systems, a wireless communications resource may refer to a combination of a radio frequency spectrum resource, a time resource, and a spatial resource (e.g., spatial layers), and the use of multiple spatial layers may further increase the data rate for communications with a UE 115.

Devices of the wireless communications system 100 (e.g., base stations 105 or UEs 115) may have a hardware configuration that supports communications over a particular carrier bandwidth, or may be configurable to support communications over one of a set of carrier bandwidths. In some examples, the wireless communications system 100 may include base stations 105 and/or UEs 115 that support simultaneous communications via carriers associated with more than one different carrier bandwidth.

Wireless communications system 100 may support communication with a UE 115 on multiple cells or carriers, a feature which may be referred to as carrier aggregation or multi-carrier operation. A UE 115 may be configured with multiple downlink component carriers and one or more uplink component carriers according to a carrier aggregation configuration. Carrier aggregation may be used with both FDD and TDD component carriers.

In some cases, wireless communications system 100 may utilize enhanced component carriers (eCCs). An eCC may be characterized by one or more features including wider carrier or frequency channel bandwidth, shorter symbol duration, shorter TTI duration, or modified control channel configuration. In some cases, an eCC may be associated with a carrier aggregation configuration or a dual connectivity configuration (e.g., when multiple serving cells have a suboptimal or non-ideal backhaul link). An eCC may also be configured for use in unlicensed spectrum or shared spectrum (e.g., where more than one operator is allowed to use the spectrum). An eCC characterized by wide carrier bandwidth may include one or more segments that may be utilized by UEs 115 that are not capable of monitoring the whole carrier bandwidth or are otherwise configured to use a limited carrier bandwidth (e.g., to conserve power).

In some cases, an eCC may utilize a different symbol duration than other component carriers, which may include use of a reduced symbol duration as compared with symbol durations of the other component carriers. A shorter symbol duration may be associated with increased spacing between adjacent subcarriers. A device, such as a UE 115 or base station 105, utilizing eCCs may transmit wideband signals (e.g., according to frequency channel or carrier bandwidths of 20, 40, 60, 80 MHz, etc.) at reduced symbol durations (e.g., 16.67 microseconds). A TTI in eCC may consist of one or multiple symbol periods. In some cases, the TTI duration (that is, the number of symbol periods in a TTI) may be variable.

Wireless communications system 100 may be an NR system that may utilize any combination of licensed, shared, and unlicensed spectrum bands, among others. The flexibility of eCC symbol duration and subcarrier spacing may allow for the use of eCC across multiple spectrums. In some examples, NR shared spectrum may increase spectrum utilization and spectral efficiency, specifically through dynamic vertical (e.g., across the frequency domain) and horizontal (e.g., across the time domain) sharing of resources.

In some examples, the wireless communications system 100 may be configured with a plurality of areas in which one or more single-frequency networks (SFNs) are established for communicating paging signals. Non-limiting examples of the areas associated with SFNs may include a tracking area (TA), a radio access network area code (RAN-AC), a radio access network based notification area (RNA).

To improve power conservation techniques related to paging procedures, the wireless communications system 100 may implement coordinated paging techniques in a joint paging area. Base stations 105 in the wireless communications system 100 may coordinate their existing paging channels and parameters to efficiently page a UE 115. The cells which coordinate and implement these techniques may form the joint paging area. Each joint paging area may be controlled by a primary base station 105. All cells in a joint paging area may use the same paging parameters for Idle and Inactive RRC modes. This may include parameters for a default paging cycle, a number of paging occasions per cycle, offset for the paging frame, offsets for the paging occasions, a paging search space or any combination thereof.

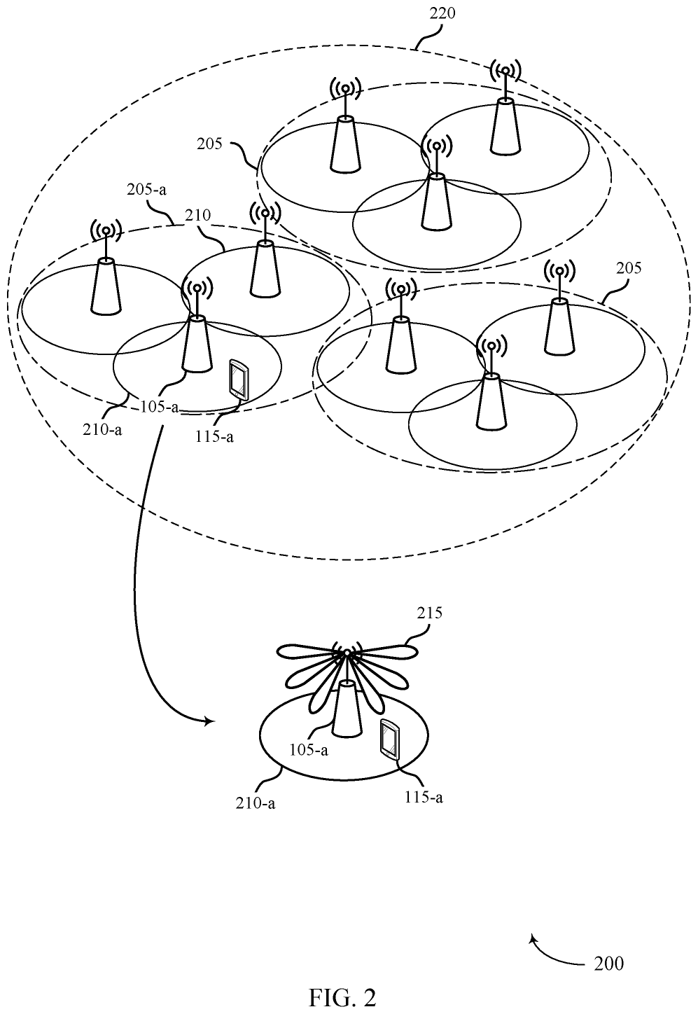

FIG. 2 illustrates an example of a wireless communications system 200 that supports coordination and transmission of joint paging in accordance with aspects of the present disclosure. In some examples, the wireless communications system 200 may implement aspects of wireless communication system 100. The wireless communication system 200 may include one or more base stations 105 and one or more UEs 115, for example including base station 105-a and UE 115-a. The base stations 105 described in FIG. 2 may be examples of the base stations 105 described with reference to FIG. 1. In some examples, base station 105-a may be referred to as a network device and/or a next generation NodeB (gNB). UE 115-a may be an example of a UE 115 described with reference to FIG. 1.

The wireless communication system 200 may illustrate operations of and communications between the base stations 105 and the UEs 115 that support coordination and transmission of joint paging. Each base station 105 may provide a cell 210, where a base station 105 can provide service for a UE 115 within the coverage area of the cell 210. In some cases, multiple cells 210 may form a radio access network (RAN) based notification area (RNA) 205. In some cases, one or more RNAs 205 may make up a tracking area 220. Thus, the tracking areas 220, RNAs 205, and cells 210 may provide different levels of granularity for finding a UE 115. For example, UE 115-a may be in the tracking area 220, RNA 205-a, and served by cell 210-a. If the network has a paging message to send UE 115-a, the network may determine the most recent tracking area 220 and RNA 205 of UE 115-a, then the network may provide the paging message to each base station 105 in the RNA 205.

UE 115-a may be configured to operate in multiple different RRC states. At any given time, UE 115-a may be in a single RRC state of a set of RRC states. Some RRC states of the set RRC states may include an RRC connected state, an RRC inactive state, and an RRC idle state. The RRC idle state may be used for initial access to a network or to reduce power consumption of UE 115-a. In the RRC idle state, UE 115-a may sleep and operate according to a discontinuous reception (DRX) configuration to periodically monitor for paging messages. The DRX mechanism may be configured by a protocol layer, such as by RRC signaling. In the idle state, the network and UE 115 may not maintain any RRC context. The UE 115 may re-establish an RRC context with the network upon performing an RRC establishment procedure and transitioning to the RRC connected state.

The RRC connected state may be used for active data transfer in the network. UE 115-a may be connected with the network for both control and user planes to communicate control and data information with the serving cell. In some cases, UE 115-a may enter the RRC connected state after performing an attach procedure to a cell in the network. Both the network and UE 115-a may have RRC context while UE 115-a is in the RRC connected mode. In some examples, UE 115-a may operate in the RRC inactive state to reduce power consumption. UE 115-a may also operate according to the DRX configuration while in the RRC inactive state, but UE 115-a may maintain the RRC context (e.g., unlike the RRC idle state). Thus, UE 115-a in the RRC inactive mode may quickly go from the sleeping and conserving power usage to communicating data with a serving cell. In some examples, UE 115-a may perform updates in an RNA 205 when operating in the RRC inactive state. Additionally or alternatively, UE 115-a may perform updates when UE 115-a moves outside the RNA in the RRC inactive state.

UE 115-a may transition between RRC states via one or more procedures. For example, the UE 115-a may use an establish procedure to transition from the RRC idle to the RRC connected state. The establish procedure may include establishing an RRC connection with the network. In some cases, such as if there is no activity from UE 115-a after a period of time, an RRC suspend procedure may transition the RRC state of UE 115-a from the RRC connected or RRC inactive state. In some cases, UE 115-a may release its RRC connection to transition from the RRC connected state to the disconnected or idle state. UE 115-a may be configured perform an RRC resume procedure to transition from the RRC inactive state to the RRC connected state. If UE 115-a experiences connection failure while in either the RRC connected or RRC inactive state, UE 115-a may transition to the RRC idle state.

When UE 115-a is operating in the RRC inactive state or the RRC idle state, UE 115-a may monitor for a variety of different signals to maintain the communication link with the network. For example, UE 115-a may monitor for synchronization signals, reference signals, and/or for paging signals. UE 115-a may monitor for monitor for synchronization signals (e.g., primary synchronization signal or secondary synchronization signal) to obtain or maintain the cell identity and/or to obtain or maintain the frame timing, among other things. UE 115-a may monitor for paging signals from the network when in a DRX mode (e.g., RRC idle state or RRC inactive state) that indicate the network (e.g., the base station 105-a) includes information waiting to be communicated to UE 115-a. For example, base station 105-a may receive an incoming call or incoming data that is addressed to UE 115-a. Base station 105-a may page UE 115-a (e.g., by transmitting a paging message) based on receiving the incoming call or data.

UE mobility, or the operations of the UE 115 as it moves around different areas (e.g., RNAs 205, cells 210, or tracking area 220), may be based on the RRC mode. For example, while in RRC connected mode, the network may track which cell UE 115-a is attached to at any point. If UE 115-a moves from a first cell 210 to a second cell 210, UE 115-a and the corresponding base stations 105 may perform an inter-cell handover to move the UE 115-a to the second cell 210. In some cases, handovers between cells 210 or beams 215 of a cell 210 may be determined based on measurements made by UE 115-a. If UE 115-a is in RRC inactive mode, UE 115-a may maintain an anchor base station 105, but UE 115-a may be able to freely move around an RNA 205. For example, base station 105-a may be the anchor cell for UE 115-a, but UE 115-a may be able to move around the RNA 205-a freely without notifying the network if UE 115-a moves to a different cell in the RNA 205-a. If UE 115-a moves to a different RNA 205, UE 115-a may notify the network of the change. If UE 115-a is in idle mode, UE 115-a may move within the tracking area 220 without providing an update to the network. Thus, the network may only be aware of the UE's tracking area 220 while UE 115-a is in idle mode. As described, for idle and inactive RRC states, mobility may be handled at the device through cell reselection. For RRC connected mode, mobility may be handled by the RAN based on measurements made by the UE 115.

The wireless communication system 200 may be configured to use millimeter-wave (mmW) spectrum for communications between base stations 105 and UEs 115. Communications sent over mmW spectrum may be transmitted using a directional beam 215 formed using beamforming techniques. Such directional beams 215 may have limited spatial coverage. In some cases, network may transmit some signals using beam sweeping to address issues that may arise from the limited spatial coverage of directional beams in the mmW spectrum. Transmitting some signals by beam-sweeping directional beams may increase the amount of communication resources used to communicate such signals. For example, the network may transmit synchronization signals or paging signals on multiple beams, where the transmitting beam is changed according to a beam sweep. In such examples, UE 115-a may monitor for synchronization signals or paging signals that have been transmitted using multiple directional beams 215 via a multi-beam monitoring procedure.

In some cases, a paging procedure in conventional systems may consume considerable power at UE 115-a based on UE 115-a monitoring for reference signals and paging messages at different times. In some conventional systems, UE 115-a may monitor for paging messages from multiple different cells, each of which may transmit the paging messages on multiple different beams. UE 115-a may turn on monitoring processes to monitor for the paging messages from each of the different cells and use directional reception techniques (e.g., beamformed reception) to check for paging messages on each beam provided by the different cells. Further, UE 115-a may monitor for reference signals and synchronization signals (e.g., primary synchronization signals (PSS), secondary synchronization signals (SSS), and a physical broadcast channel (PBCH) carrying demodulation reference signals (DMRS)) from the different cells, where the synchronization signals and reference signals may also be transmitted in multiple different directions according to beam sweeping techniques. Thus, although UE 115-a is in RRC idle or RRC inactive mode to conserve power, UE 115-a may use a significant amount of power while in these modes to monitor for paging messages and reference signals.

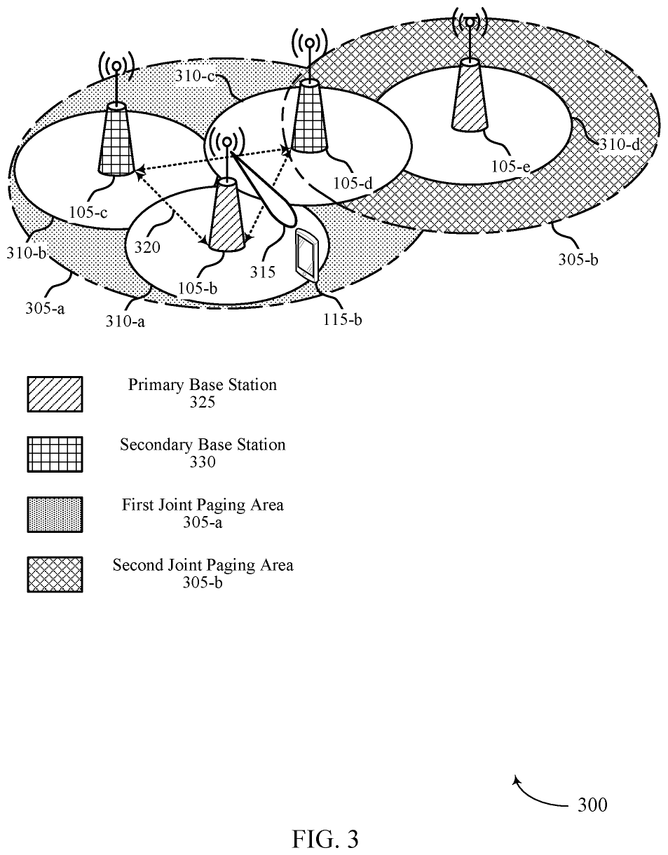

To improve power conservation techniques related to paging procedures, the wireless communications system 200 may implement coordinated paging techniques in a joint paging area. Base stations 105 in the wireless communications system 200 may coordinate their existing paging channels and parameters to efficiently page UE 115-a. The cells which coordinate and implement these techniques may form the joint paging area. Each joint paging area may be controlled by a master gNB, or a master base station. All cells in a joint paging area may use the same paging parameters for Idle and Inactive RRC modes. This may include parameters for a default paging cycle, a number of paging occasions per cycle, offset for the paging frame, offsets for the paging occasions, a paging search space or any combination thereof. These techniques and examples of these techniques are described in more detail in FIG. 3.

FIG. 3 illustrates an example of a wireless communications system 300 that supports coordination and transmission of joint paging in accordance with aspects of the present disclosure. In some examples, wireless communications system 300 may implement aspects of wireless communication system 100.

The wireless communications system 300 may include one or more base stations 105, including base stations 105-b, 105-c, 105-d and 105-e. These base stations 105 may each be an example of a base station 105 as described in FIG. 1. The wireless communications system may also include one or more UEs 115, such as UE 115-a. UE 115-a may be an example of a UE 115 as described in FIG. 1.

Each base station 105 may provide a cell 310. For example, base station 105-b may provide cell 310-a, base station 105-c may provide cell 310-b, base station 105-d may provide cell 310-c, and base station 105-e may provide cell 310-d. UE 115-b may at one point be in an RRC connected mode and attached to base station 105-b. If UE 115-b moves to an RRC inactive mode, base station 105-b may be considered the anchor base station 105. The base stations may be connected via backhaul links 320. An Xn interface may be an example of a backhaul link 320. The backhaul links 320 may provide lossless and time efficient communications between the base stations 105.

Base station 105-b and base station 105-e may each be an example of a primary base station 325. Base stations 105-c and base station 105-d may be examples of secondary base stations 330. A primary base station 325 may, in some cases, be referred or be an example of a master base station. The primary base stations 325 may control respective joint paging areas 305. For example, base station 105-b may control a first joint paging area 305-a, and base station 105-e may control a second joint paging area 305-b.

A joint paging area 305 may be created by a primary base station 325 or by another entity, such as a central network unit or an operation and maintenance (O&M) system. In an example, base station 105-b may create joint paging area 305-a, and base station 105-e may create joint paging area 305-b. Each joint paging area may have a single primary base station 325. In some cases, an O&M system may designate a base station 105 as a primary base station 325. The primary base station 325 may decide on a configuration for the joint paging area 305 after communicating with neighboring cells 310 using an Xn interface (e.g., via the backhaul links 320). The primary base station 325 may exchange, with the neighboring base station 105, capability information, channel configurations, other configurations, or any combination thereof, to set up the joint paging area 305. For example, base station 105-b may communicate with base station 105-c, base station 105-d, or both, to exchange capability and configuration information. Both base station 105-c and base station 105-d may signal that they are capable of supporting a joint paging area 305, so base station 105-b may set up the first joint paging area 305-b. Similarly, base station 105-e may communicate with base station 105-d and any other neighboring base stations 105 and configure the second joint paging area 305-b. The primary base station 325 may inform the other base stations 105 of the configuration for the joint paging area 305. In some cases, an access and mobility management function (AMF), or another node behaving similarly to a primary base station 325, may create a joint paging area 305.

A base station 105 may belong to multiple joint paging areas 305. For example, base station 105-d may belong to the first joint paging area 305-a and the second joint paging area 305-b. In some cases, a base station 105 may be a primary base station 325 for one joint paging area 305 and a secondary base station 330 for a second joint paging area 305. In some cases, different joint paging areas 305 may use different paging occasions in time and/or frequency.

The primary base stations 325 may use the backhaul links 320 to suggest parameters for the joint paging area 305. For example, base station 105-b may suggest parameters for the first joint paging area 305-a to base station 105-c and base station 105-d over the backhaul links 320. The other nodes (e.g., base station 105-c and base station 105-d) may accept the suggested parameters or suggest modifications to the suggested parameters. The primary base station 325 may decide on the final parameters for the joint paging area 305 and inform the other nodes of the final parameters using the backhaul links 320. In some cases, the coordinate between cells 310 may be done via implementation if the cells 310 belong to the same gNB or control unit. For different gNBs, coordination may occur over Xn interface or via broadcast signaling.

The cells 310 in a joint paging area 305 may use the same paging parameters for idle and inactive mode. For example, when UE 115-b is in idle mode or RRC inactive mode, base station 105-b, base station 105-c, and base station 105-d may employ the same paging parameters when paging UE 115-b. These parameters may include the default paging cycle, a number of paging occasions per cycle, an offset for the paging frame, offsets for the paging occasions, physical channel parameters, a paging search space, or any combination thereof. These parameters may be used if a new physical channel is used as well. For example, if base station 105-b employs a new physical channel or uses a different physical channel, base station 105-b may use the paging parameters of the first joint paging area 305-a for the new physical channel. The base stations 105 in a joint paging area 305 may also use the same paging physical channel parameters for a UE 115 in idle mode or RRC inactive mode. For example, the base stations may use the same configuration of physical downlink control channel (PDCCH) and physical downlink shared channel (PDSCH) for the UE 115 to receive the paging. These physical channel configurations may be used (e.g., by default) if the base stations 105 in the joint paging area 305 use a new physical channel.

In some cases, a base station 105 may broadcast paging parameters for other cells in the joint paging area 305. For example, base station 105-b may broadcast the paging parameters for base station 105-d and base station 105-c. In some cases, the paging parameters for cells 310 in the joint paging area 305 may be include in an RRC release or RRC reconfiguration message. However, if UE 115-a moves to a cell 310 which did not have parameters included in the RRC release or resource release message, then one or more base stations 105 in the joint paging area 305 may broadcast the paging parameters for that cell 310. By broadcasting the paging parameters, UE 115-b may receive the paging parameters without reading SIB1 when it moves to another cell in the first joint paging area 305-a. Thus, UE 115-b may roam within the first paging area 305-a and move to another cell in the joint paging area 305-a without reading SIB1 from that cell.

The joint paging configuration may employ techniques for UE 115-b to camp on a cell without reading SIB1 parameters during cell reselection. These techniques may also be implemented when cells do not coordinate (for a single paging transmission. In some cases, the paging parameters may be broadcasted to assist UE 115-b with cell reselection. Then, based on the broadcasted information, UE 115-b has information when selecting a cell to camp on. The cells which have their paging parameters broadcasted can be identified by a physical cell ID (PCI) or another cell identity included in the broadcast. In some cases, multiple joint paging areas 305 may be configured for different paging occasions. For example, the first joint paging area 305-a may be configured for a first paging occasion, and the second joint paging area 305-b may be configured for a second joint paging occasion, which may be different in time resources, frequency resources, or both.

For inactive RRC mode, the anchor base station 105 may configure the UE 115 with parameters for the joint paging area 305 in the RNA. For example, UE 115-b may have been connected to base station 105-b while in the RRC active mode. Base station 105-d may configure UE 115-b to enter the RRC inactive mode, for example by transmitting an RRC suspend message or RRC release message to UE 115-b. In some cases, the last-connected base station 105 may be the anchor base station 105 for UE 115-b. Thus, the anchor base station 105 may obtain the parameters of the other joint paging areas 305 (e.g., the joint paging areas 305 to which the anchor base station 105 does not belong) and provide the configuration to UE 115-b in an RRC release or RRC suspend message. UE 115-b may use the parameters of the new joint paging area 305 when it switches to the new joint paging area 305 based on the configuration. For example, should UE 115-b switch to a new joint paging area 305, UE 115-b may use the joint paging parameters which were included in the configuration provided by the anchor base station 105.

In some cases, an RNA may include multiple joint paging areas 305. For example, the first joint paging area 305-a and the second joint paging area 305-b may belong to the same RNA. In some examples, an RNA may include multiple joint area parameters. Thus, when UE 115-b is released to RRC inactive mode, the anchor base station 105 may configure UE 115-b with joint paging parameters for the RNA to support UE mobility for a UE 115 in the RRC inactive state. Thus, UE 115-b may roam within the RNA and be configured with joint paging parameters for any joint paging area 305 in the RNA.

UE 115-b may also obtain cell barring and cell camping parameters for neighboring cells belonging to the joint paging area 305. For example, UE 115-b may have been attached to base station 105-b (e.g., base station 105-b is the anchor base station 105), and base station 105-b may provide UE 115-b with cell barring and cell camping parameters for base station 105-c and base station 105-d, which are the other base stations in the first joint paging area 305-a. Cell barring parameters may include cell access related information (e.g., cellAccessRelatedInfo) and camping parameters may include cell selection information (e.g., cellSelectionInfo). The cell barring and cell camping parameters may be provided to UE 115-b in an RRC release message while moving to idle and RRC connected modes. Additionally, or alternatively, the cell barring and camping parameters may be broadcasted when UE 115-b moves to cells which were not included in the RRC release message.

The base stations 105 may exchange and update cell barring and cell camping parameters by communicating over Xn interfaces (e.g., the backhaul links 320). In some cases, the anchor base station 105 may provide UE 115-b with SIB1 information in an RRC release message such that UE 115-b can camp on other cells without having to decode a SIB1 message. Thus, the techniques described herein may enable a UE 115 to camp on a cell without reading SIB1 from that cell. As described, in some cases the UE 115 may not read SIB1 parameters during cell re-selection in a joint paging area 305.

In some cases, the base stations 105 in a joint paging area 305 may initiate RAN paging when joint paging parameters change. For example, paging may be initiated if cell barring or cell camping parameters of a cell 310 in the RNA change. If paging parameters change, the base stations 105 in the first joint paging area 305-a may page UE 115-b and inform UE 115-b of the changes. The cells 310 in the joint paging area 305 may inform each other when the cell barring or cell camping parameters are changed (e.g., over a backhaul link 320 such as an Xn interface). The paging may indicate the one or more PCIs for the one or more cells which had the change. For example, if cell barring or cell camping parameters for base station 105-c and base station 105-d change, the RAN paging may indicate the PCIs for base station 105-c and base station 105-d. Therefore, the UEs 115 which are not camped on those cells may not read, or may defer, the SIB1 messages from those cells until the UEs 115 move to one of those cells. In some cases, the paging message may use indices or a bitmap which is configured in the RRC release message instead of actual PCIs to reduce (e.g., minimize) paging overhead. For example, instead of including the full PCI for base station 105-c, base station 105-c may instead correspond to a bit of a bitmap which is included in the RRC release message. If the bit corresponding to base station 105-c is toggled, UE 115-b may determine that the cell camping or cell barring parameters for base station 105-c have been updated. UE 115-b may then defer reading a SIB1 message from base station 105-c until UE 115-b is in cell 310-b of base station 105-c.

The UE context may include a capability of whether the UE 115 can support joint paging. For example, UE 115 may transmit a capability message to anchor base station 105 indicating a capability of the UE 115 to receive joint paging, and the anchor base station 105 may generate a UE context based on the capability message. The UE context may be stored at the anchor base station 105 while the UE 115 is in the RRC inactive mode. For example, base station 105-b may store the UE context for UE 115-b. The UE context for UE 115-b may include an indicator that UE 115-b is capable for joint paging. In some cases, a base station 105 may only store a capability indicator for joint paging if the UE 115 can support joint paging. UEs 115 which do not support joint paging may be paged using other (e.g., conventional) paging techniques. In some cases, as UE 115-b moves within the RNA and camps on another cell 310, the UE context may be moved to the base station 105 providing that cell 310.

A paging message may include an indicator as to whether the paging message is initiated from the core network or from the RAN. In some cases, a paging message which is initiated by the core network may use a different UE identifier than a paging message which is initiated at the RAN (e.g., initiated by a base station 105 of the RAN).

As described herein, each base station 105 in a joint paging area 305 may use the same paging message to page a UE 115 based on the joint paging parameters. Thus, base station 105-b, base station 105-c, and base station 105-d may use the same joint paging parameters to generate a joint paging message to page UE 115-b. Thus, all cells in a joint paging area 305 may use the same paging parameters for idle and inactive mode. UE 115-b may also have these paging parameters. For example, UE 115-b may be provided the paging parameters in an RRC release, detach, or RRC suspend message. Additionally, or alternatively, the paging parameters may be broadcasted, and UE 115-b may be able to receive the paging parameters from the broadcast messages without reading SIB1 messages.

UE 115-b may monitor the paging frame and paging occasion based on the configuration. The paging parameters may be provided to UE 115-b in an RRC release message when UE 115-b transitions to RRC inactive. The RRC release message may provide the paging frame and paging occasion for the joint paging area. UE 115-b may then monitor for paging messages in the paging frame and paging occasion based on the paging parameters. In some cases, such as if UE 115-b is in idle mode, UE 115-b may calculate the paging frame and paging occasion (e.g., based on SIB1 information provided in the RRC release message) and monitor based on the calculated paging frame and paging occasion. If UE 115-b is in RRC inactive mode, parameters received in an RRC release message may overwrite calculated parameters. In some cases, UE 115-b may move to another joint paging area 305, such from the first joint paging area 305-a to the second joint paging area 305-b. In some examples, the anchor base station 105 may have configured UE 115-b with paging parameters for other joint paging area 305 (e.g., including the second joint paging area 305-b) in the RRC release message. In some cases, UE 115-b may use these parameters if UE 115-b moves to the second joint paging area 305-b while in RRC inactive mode. In some other examples, UE 115-b may notify the RNA and receive a second set of paging parameters for the second joint paging area 305-b.

In the idle mode, UE 115-b may receive information when it camps on a cell 310 outside of a previous joint paging area 305, such as whether the cell 310 supports joint paging. For example, UE 115-b may receive the paging information for the new joint paging area 305 via a broadcast from a base station 105 in the new joint paging area 305. For example, UE 115-b may move from the first joint paging area 305-a to the second joint paging area 305-b while UE 115-b is in idle mode. UE 115-b may camp on base station 105-d and receive a broadcast signal from base station 105-d which conveys joint paging parameters for the second joint paging area 305-b. In some cases, UE 115-b may calculate a paging frame and paging occasion based on the broadcasted parameters. Therefore, UE 115-b may receive the paging parameters for the second joint paging area 305-b without decoding a SIB1 message from base station 105-d.

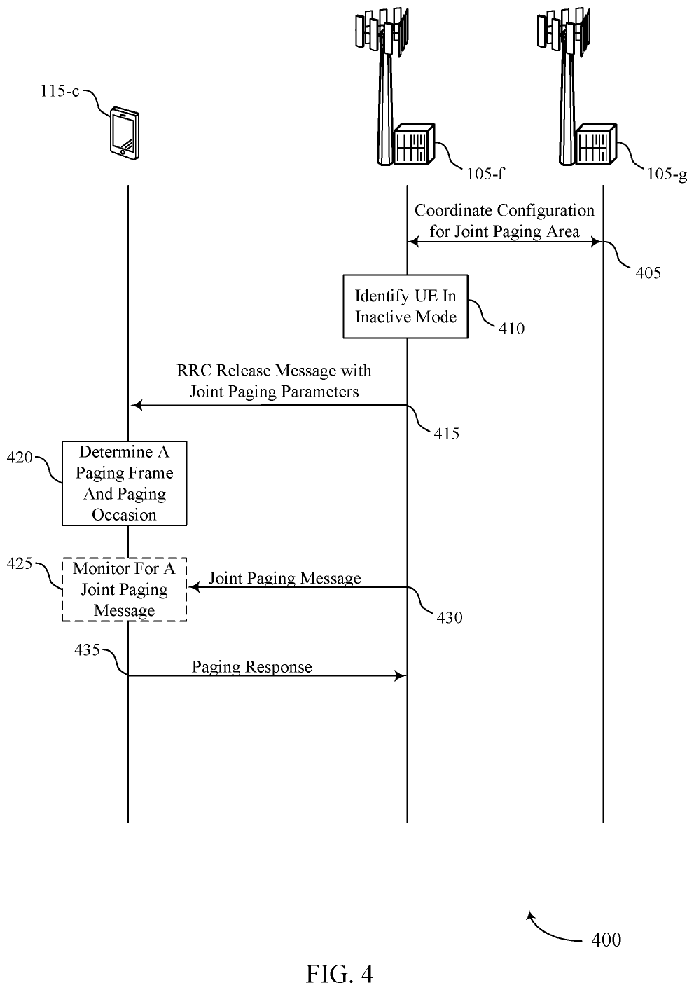

FIG. 4 illustrates an example of a process flow 400 that supports coordination and transmission of joint paging in accordance with aspects of the present disclosure. In some examples, process flow 400 may implement aspects of wireless communication system 100.

The process flow 400 may include UE 115-c, base station 105-f, and base station 105-g. UE 115-d may be an example of a UE 115 as described herein. Base station 105-h and base station 105-i may each be an example of a base station 105 as described herein. In some cases, base station 105-h may be an example of a primary base station, and base station 105-i may be an example of a secondary base station. In other examples, base station 105-i may be an example of a primary base station, and base station 105-h may be an example of a secondary base station.

At 405, base station 105-f may coordinate with a second base station (e.g., base station 105-g) to define a configuration for a joint paging area for idle mode paging, inactive mode paging, or both. For example, base station 105-f and base station 105-g may exchange capability information, channel configuration, or both. In some cases, such as where base station 105-f is the primary base station and base station 105-g is a secondary base station for the paging area, base station 105-f may receive a suggested modification to at least one of the one or more joint paging parameters. The primary base station may decide on the final joint paging area configuration after coordinating with neighbors (e.g., over an Xn interface) and transmit the configuration to base station 105-g. In some cases, other base stations 105 (not shown) may also be included and the joint paging area, and these other base stations 105 may coordinate with base station 105-f and base station 105-g to determine the joint paging area configuration.

At 410, base station 105-f may identify UE 115-c within the joint paging area. In some cases, UE 115-c may be operating in an inactive mode or an idle mode. Base station 105-f may configure UE 115-c with the joint paging area configuration. In the following example, UE 115-c may operate in the inactive mode. In other embodiments, UE 115-c may operate in the idle mode.

At 415, base station 105-f may transmit one or more joint paging parameters for the joint paging area that correspond to the configuration. In some cases, base station 105-f may transmit, to UE 115-c, an RRC release message or a radio resource release message that includes the one or more joint paging parameters. The one or more joint paging parameters may include one or more of a default paging cycle, a number of paging occasions per cycle, an offset for a paging frame, one or more offsets for each paging occasion, a paging search space, one or more physical channel parameters, or any combination thereof. In some cases, UE 115-c may have been in a connected mode, and UE 115-c may transition to the inactive mode upon receiving the RRC release message or resource release message.

At 420 UE 115-c may determine a paging frame and a paging occasion based on the one or more joint paging parameters. At 425, UE 115-c may monitor, while in the inactive mode, for a joint paging message based on the one or more joint paging parameters. In some cases, UE 115-c may monitor for the joint paging message based on the paging frame and the paging occasion. UE 115-c may monitor for paging messages according to the joint paging area configuration. For example, UE 115-c may enter a sleep mode or low power mode except for when UE 115-c is monitor for a paging message. The paging frame and paging occasion may be periodic, and UE 115-c may monitor for paging messages according to the joint paging area configuration and the joint paging parameters until UE 115-c receives a paging message.

At 430, base station 105-f may transmit a joint paging message to UE 115-c in accordance with the configuration. In some cases, base station 105-f may transmit the joint paging message based on detecting a pending message for UE 115-c. In some cases, the joint paging message may indicate that the joint paging message is initiated from a core network or a radio access network. In some cases, base station 105-f may transmit the joint paging message during the first paging occasion, or base station 105-f may transmit the joint paging message at any paging occasion thereafter (e.g., based on the periodicity of the paging occasion and paging frame). At 435, UE 115-c may transmit a paging response message based on the joint paging message. In some examples, UE 115-c may subsequently transition from an idle or inactive state to a connected state (e.g., RRC connected state) for transmit data to and/or receive data from the network via base station 105-f and/or base station 105-g.

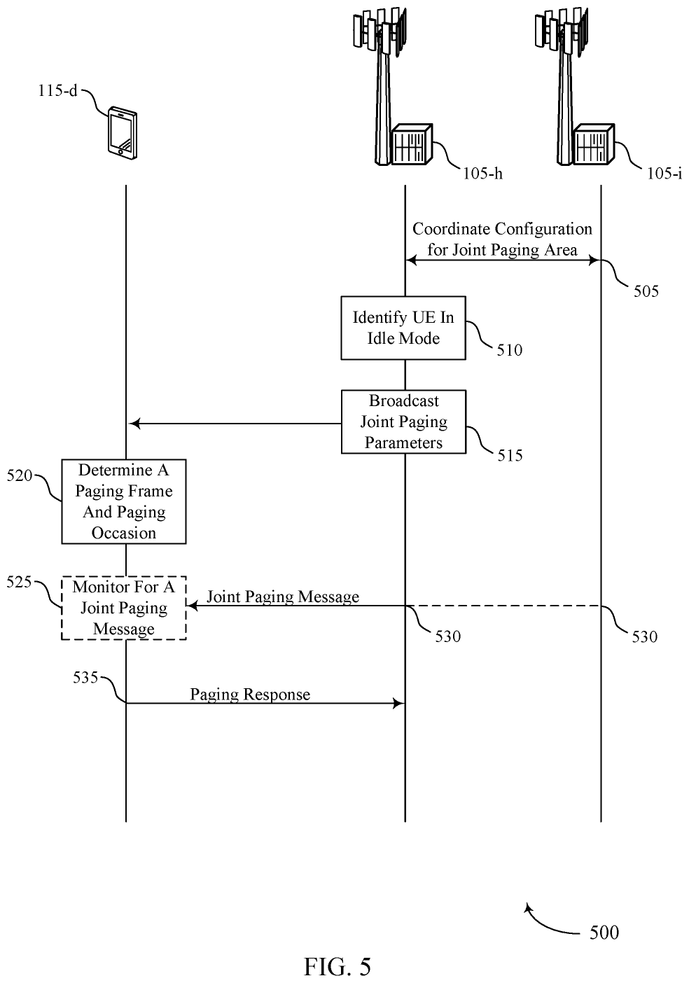

FIG. 5 illustrates an example of a process flow 500 that supports coordination and transmission of joint paging in accordance with aspects of the present disclosure. In some examples, process flow 500 may implement aspects of wireless communication system 100.

The process flow 500 may include UE 115-d, base station 105-h, and base station 105-i. UE 115-d may be an example of a UE 115 as described herein. Base station 105-h and base station 105-i may each be an example of a base station 105 as described herein. In some cases, base station 105-h may be an example of a primary base station, and base station 105-i may be an example of a secondary base station. In other examples, base station 105-i may be an example of a primary base station, and base station 105-h may be an example of a secondary base station.

At 505, base station 105-h may coordinate with a second base station (e.g., base station 105-i) to define a configuration for a joint paging area for idle mode paging, inactive mode paging, or both. For example, base station 105-h and base station 105-i may exchange capability information, channel configuration, or both. In some cases, such as where base station 105-h is the primary base station and base station 105-i is a secondary base station for the paging area, base station 105-h may receive a suggested modification to at least one of the one or more joint paging parameters. The primary base station may decide on the final joint paging area configuration after coordinating with neighbors (e.g., over an Xn interface) and transmit the configuration to the secondary base stations in the joint paging area. In some cases, other base stations 105 (not shown) may also be included and the joint paging area, and these other base stations 105 may coordinate with base station 105-h and base station 105-i to determine the joint paging area configuration.

At 510, base station 105-h may identify UE 115-d within the joint paging area. In some cases, UE 115-d may be operating in an inactive mode or an idle mode. Base station 105-h may configure UE 115-d with the joint paging area configuration. In the following example, UE 115-d may operate in the idle mode.

At 515, base station 105-h may transmit one or more joint paging parameters for the joint paging area that correspond to the configuration. In some cases, base station 105-h may broadcast the one or more joint paging parameters. The one or more joint paging parameters may include one or more of a default paging cycle, a number of paging occasions per cycle, an offset for a paging frame, one or more offsets for each paging occasion, a paging search space, one or more physical channel parameters, or any combination thereof. In some cases, UE 115-d may monitor for the broadcast carrying the one or more joint paging parameters while UE 115-d is in an RRC idle mode. By receiving the one or more joint paging parameters in a broadcasted message, UE 115-d may retrieve the joint paging parameters without having to decode a SIB1 message.

At 520 UE 115-d may determine a paging frame and a paging occasion based on the one or more joint paging parameters. At 525, UE 115-d may monitor, while in the idle mode, for a joint paging message based on the one or more joint paging parameters. In some cases, UE 115-d may monitor for the joint paging message based on the paging frame and the paging occasion. UE 115-d may monitor for paging messages according to the joint paging area configuration. For example, UE 115-d may enter a sleep mode or low power mode except for when UE 115-d is monitor for a paging message. The paging frame and paging occasion may be periodic, and UE 115-d may monitor for paging messages according to the joint paging area configuration and the joint paging parameters until UE 115-d receives a paging message. In some cases, UE 115-d may monitor for the joint paging messages based on a DRX cycle.

At 530, base station 105-h may transmit a joint paging message to UE 115-d in accordance with the configuration. In some cases, base station 105-i and any other base station 105 configured with the joint paging area configuration in the joint paging area may transmit the joint paging message to UE 115-d in according with the configuration. In some cases, base station 105-h may transmit the joint paging message based on detecting a pending message for UE 115-d. In some cases, the joint paging message may indicate that the joint paging message is initiated from a core network or a radio access network. In some cases, base station 105-h may transmit the joint paging message during the first paging occasion, or base station 105-h may transmit the joint paging message at any paging occasion thereafter (e.g., based on the periodicity of the paging occasion and paging frame). At 535, UE 115-d may transmit a paging response message based on the joint paging message. In some examples, UE 115-c may subsequently transition from an idle or inactive state to a connected state (e.g., RRC connected state) for transmit data to and/or receive data from the network via base station 105-h and/or base station 105-i.

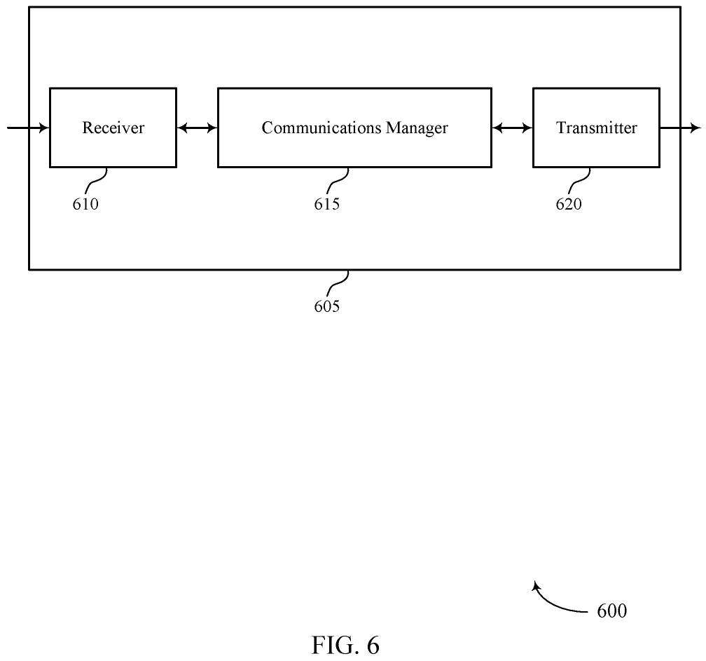

FIG. 6 shows a block diagram 600 of a device 605 that supports coordination and transmission of joint paging in accordance with aspects of the present disclosure. The device 605 may be an example of aspects of a UE 115 as described herein. The device 605 may include a receiver 610, a communications manager 615, and a transmitter 620. The device 605 may also include a processor. Each of these components may be in communication with one another (e.g., via one or more buses).

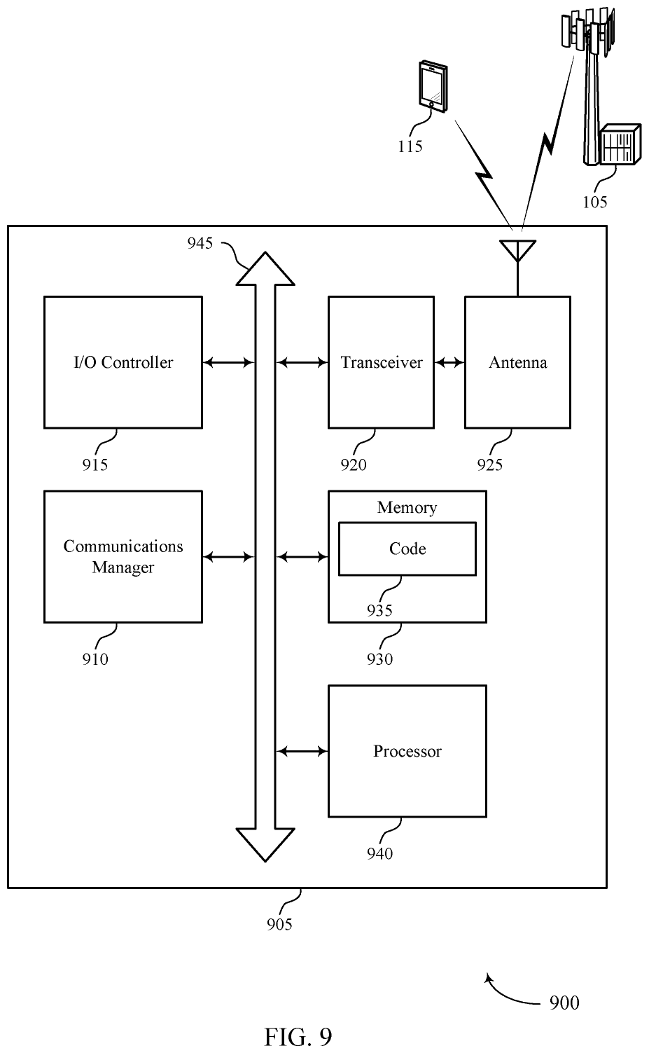

The receiver 610 may receive information such as packets, user data, or control information associated with various information channels (e.g., control channels, data channels, and information related to coordination and transmission of joint paging, etc.). Information may be passed on to other components of the device 605. The receiver 610 may be an example of aspects of the transceiver 920 described with reference to FIG. 9. The receiver 610 may utilize a single antenna or a set of antennas.

The communications manager 615 may receive one or more joint paging parameters for a joint paging area for idle mode paging, inactive mode paging, or both and monitor, while in an inactive mode or an idle mode, for a joint paging message based on the one or more joint paging parameters. The communications manager 615 may be an example of aspects of the communications manager 910 described herein.

The communications manager 615, or its sub-components, may be implemented in hardware, code (e.g., software or firmware) executed by a processor, or any combination thereof. If implemented in code executed by a processor, the functions of the communications manager 615, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 615, or its sub-components, may be physically located at various positions, including being distributed such that portions of functions are implemented at different physical locations by one or more physical components. In some examples, the communications manager 615, or its sub-components, may be a separate and distinct component in accordance with various aspects of the present disclosure. In some examples, the communications manager 615, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 620 may transmit signals generated by other components of the device 605. In some examples, the transmitter 620 may be collocated with a receiver 610 in a transceiver module. For example, the transmitter 620 may be an example of aspects of the transceiver 920 described with reference to FIG. 9. The transmitter 620 may utilize a single antenna or a set of antennas.

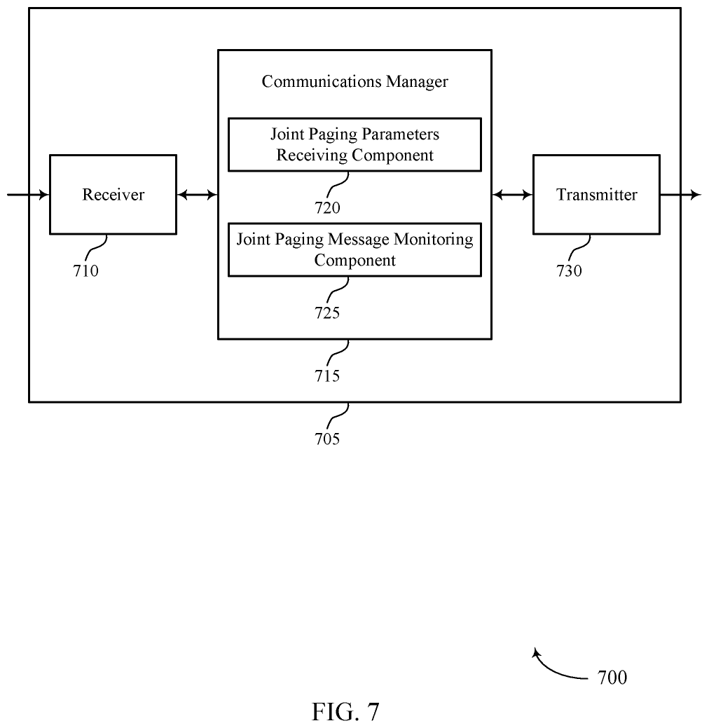

FIG. 7 shows a block diagram 700 of a device 705 that supports coordination and transmission of joint paging in accordance with aspects of the present disclosure. The device 705 may be an example of aspects of a device 605, or a UE 115 as described herein. The device 705 may include a receiver 710, a communications manager 715, and a transmitter 730. The device 705 may also include a processor. Each of these components may be in communication with one another (e.g., via one or more buses).

The receiver 710 may receive information such as packets, user data, or control information associated with various information channels (e.g., control channels, data channels, and information related to coordination and transmission of joint paging, etc.). Information may be passed on to other components of the device 705. The receiver 710 may be an example of aspects of the transceiver 920 described with reference to FIG. 9. The receiver 710 may utilize a single antenna or a set of antennas.

The communications manager 715 may be an example of aspects of the communications manager 615 as described herein. The communications manager 715 may include a joint paging parameters receiving component 720 and a joint paging message monitoring component 725. The communications manager 715 may be an example of aspects of the communications manager 910 described herein.

The joint paging parameters receiving component 720 may receive one or more joint paging parameters for a joint paging area for idle mode paging, inactive mode paging, or both. The joint paging message monitoring component 725 may monitor, while in an inactive mode or an idle mode, for a joint paging message based on the one or more joint paging parameters.

The transmitter 730 may transmit signals generated by other components of the device 705. In some examples, the transmitter 730 may be collocated with a receiver 710 in a transceiver module. For example, the transmitter 730 may be an example of aspects of the transceiver 920 described with reference to FIG. 9. The transmitter 730 may utilize a single antenna or a set of antennas.

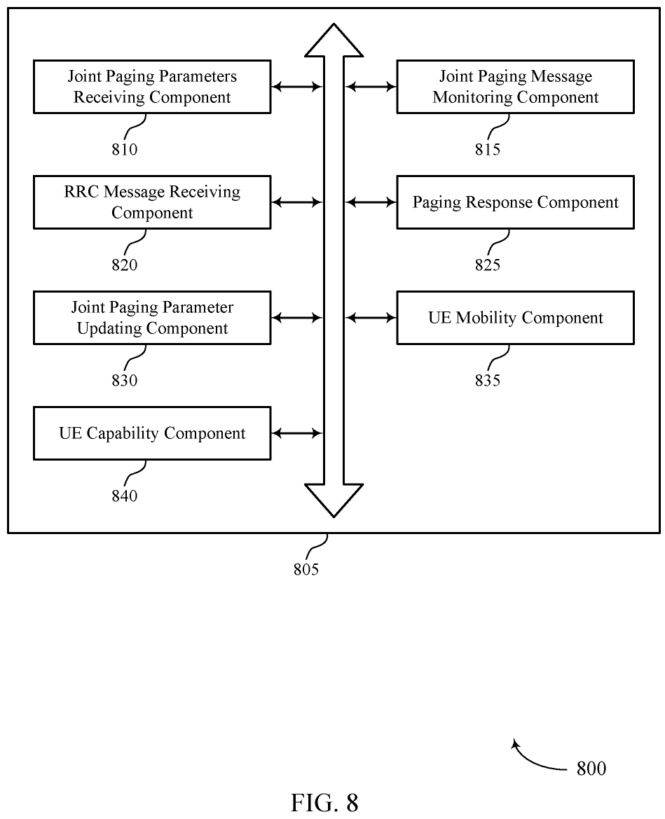

FIG. 8 shows a block diagram 800 of a communications manager 805 that supports coordination and transmission of joint paging in accordance with aspects of the present disclosure. The communications manager 805 may be an example of aspects of a communications manager 615, a communications manager 715, or a communications manager 910 described herein. The communications manager 805 may include a joint paging parameters receiving component 810, a joint paging message monitoring component 815, an RRC message receiving component 820, a paging response component 825, a joint paging parameter updating component 830, an UE mobility component 835, and an UE capability component 840. Each of these modules may communicate, directly or indirectly, with one another (e.g., via one or more buses).

The joint paging parameters receiving component 810 may receive one or more joint paging parameters for a joint paging area for idle mode paging, inactive mode paging, or both. In some examples, the joint paging parameters receiving component 810 may receive the joint paging message. In some examples, the joint paging parameters receiving component 810 may receive one or more joint paging parameters for a second joint paging area that differs from the joint paging area. In some cases, the one or more joint paging parameters include one or more of a default paging cycle, a number of paging occasions per cycle, an offset for a paging frame, one or more offsets for each paging occasion, a paging search space, one or more physical channel parameters, or any combination thereof.

The joint paging message monitoring component 815 may monitor, while in an inactive mode or an idle mode, for a joint paging message based on the one or more joint paging parameters. In some examples, the joint paging message monitoring component 815 may monitor for a second joint paging message based on the one or more joint paging parameters for the second joint paging area. In some examples, the joint paging message monitoring component 815 may monitor for the joint paging message from a first base station and a second base station, where the first base station is a primary base station and the second base station is a secondary base station.

In some examples, the joint paging message monitoring component 815 may monitor for the joint paging message from a first base station and a second base station, where the first base station is a secondary base station and the second base station is a primary base station. In some examples, the joint paging message monitoring component 815 may determine a paging frame and a paging occasion based on the one or more joint paging parameters. In some examples, the joint paging message monitoring component 815 may monitor for the joint paging message based on the paging frame and the paging occasion.

The RRC message receiving component 820 may receive a radio resource control reconfiguration message or a radio resource release message that includes the one or more joint paging parameters. The paging response component 825 may transmit a paging response based on the joint paging message.

The joint paging parameter updating component 830 may receive an update to one or more of the one or more joint paging parameters. In some examples, the joint paging parameter updating component 830 may monitor for the joint paging message in accordance with the updated one or more joint paging parameters. In some examples, the joint paging parameter updating component 830 may receive an identifier of the base station associated with the joint paging area having the updated one or more joint paging parameters. In some cases, the updated one or more joint paging parameters are an update to a cell barring parameter, a camping parameter, or both for a base station associated with the joint paging area. In some cases, the identifier is an index or a bitmap.

The UE mobility component 835 may identify that the UE has moved from the joint paging area to a second joint paging area. In some examples, the UE mobility component 835 may identify one or more second joint paging parameters for the second joint paging area for idle mode paging, inactive mode paging, or both. In some examples, the UE mobility component 835 may monitor for a second joint paging message in accordance with the one or more second joint paging parameters based on the UE operating in an inactive mode or an idle mode.

The UE capability component 840 may transmit a capability message indicating a capability of the UE to receive joint paging. In some examples, the UE capability component 840 may receive the joint paging message based on the capability message. In some cases, the joint paging message indicates that the joint paging message is initiated from a core network or a radio access network.

FIG. 9 shows a diagram of a system 900 including a device 905 that supports coordination and transmission of joint paging in accordance with aspects of the present disclosure. The device 905 may be an example of or include the components of device 605, device 705, or a UE 115 as described herein. The device 905 may include components for bi-directional voice and data communications including components for transmitting and receiving communications, including a communications manager 910, an I/O controller 915, a transceiver 920, an antenna 925, memory 930, and a processor 940. These components may be in electronic communication via one or more buses (e.g., bus 945).

The communications manager 910 may receive one or more joint paging parameters for a joint paging area for idle mode paging, inactive mode paging, or both and monitor, while in an inactive mode or an idle mode, for a joint paging message based on the one or more joint paging parameters.

The I/O controller 915 may manage input and output signals for the device 905. The I/O controller 915 may also manage peripherals not integrated into the device 905. In some cases, the I/O controller 915 may represent a physical connection or port to an external peripheral. In some cases, the I/O controller 915 may utilize an operating system such as iOS®, ANDROID®, MS-DOS®, MS-WINDOWS®, OS/2®, UNIX®, LINUX®, or another known operating system. In other cases, the I/O controller 915 may represent or interact with a modem, a keyboard, a mouse, a touchscreen, or a similar device. In some cases, the I/O controller 915 may be implemented as part of a processor. In some cases, a user may interact with the device 905 via the I/O controller 915 or via hardware components controlled by the I/O controller 915.

The transceiver 920 may communicate bi-directionally, via one or more antennas, wired, or wireless links as described above. For example, the transceiver 920 may represent a wireless transceiver and may communicate bi-directionally with another wireless transceiver. The transceiver 920 may also include a modem to modulate the packets and provide the modulated packets to the antennas for transmission, and to demodulate packets received from the antennas.

In some cases, the wireless device may include a single antenna 925. However, in some cases the device may have more than one antenna 925, which may be capable of concurrently transmitting or receiving multiple wireless transmissions.

The memory 930 may include RAM and ROM. The memory 930 may store computer-readable, computer-executable code 935 including instructions that, when executed, cause the processor to perform various functions described herein. In some cases, the memory 930 may contain, among other things, a BIOS which may control basic hardware or software operation such as the interaction with peripheral components or devices.

The processor 940 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In other cases, a memory controller may be integrated into the processor 940. The processor 940 may be configured to execute computer-readable instructions stored in a memory (e.g., the memory 930) to cause the device 905 to perform various functions (e.g., functions or tasks supporting coordination and transmission of joint paging).

The code 935 may include instructions to implement aspects of the present disclosure, including instructions to support wireless communications. The code 935 may be stored in a non-transitory computer-readable medium such as system memory or other type of memory. In some cases, the code 935 may not be directly executable by the processor 940 but may cause a computer (e.g., when compiled and executed) to perform functions described herein.

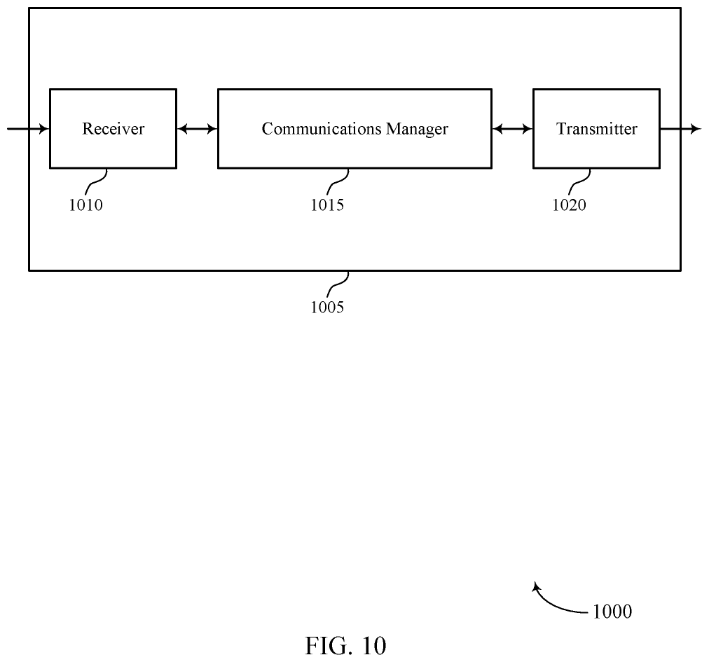

FIG. 10 shows a block diagram 1000 of a device 1005 that supports coordination and transmission of joint paging in accordance with aspects of the present disclosure. The device 1005 may be an example of aspects of a base station 105 as described herein. The device 1005 may include a receiver 1010, a communications manager 1015, and a transmitter 1020. The device 1005 may also include a processor. Each of these components may be in communication with one another (e.g., via one or more buses).

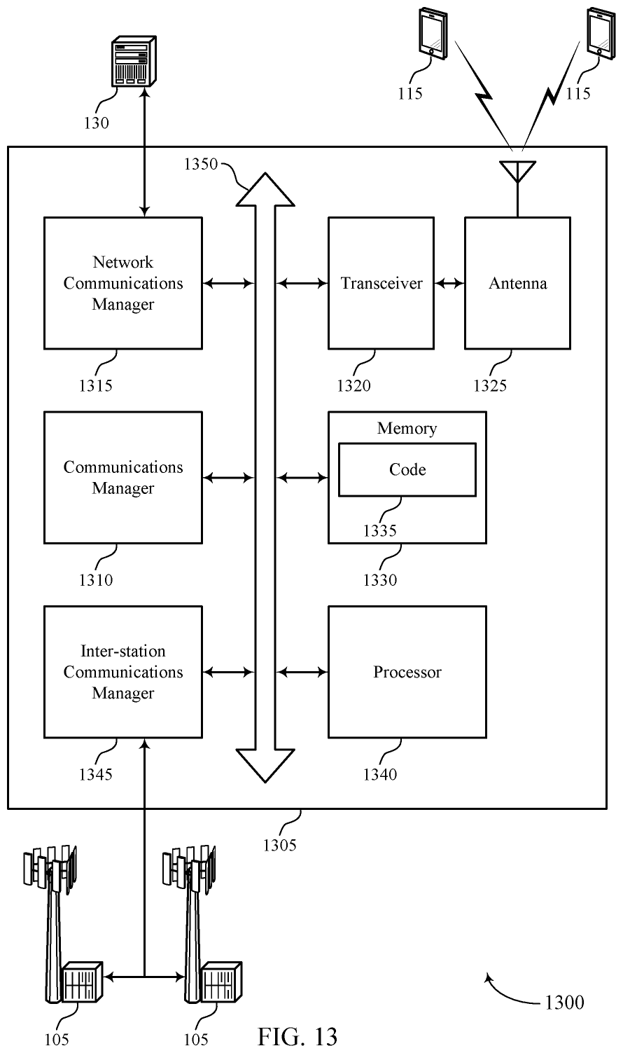

The receiver 1010 may receive information such as packets, user data, or control information associated with various information channels (e.g., control channels, data channels, and information related to coordination and transmission of joint paging, etc.). Information may be passed on to other components of the device 1005. The receiver 1010 may be an example of aspects of the transceiver 1320 described with reference to FIG. 13. The receiver 1010 may utilize a single antenna or a set of antennas.

The communications manager 1015 may coordinate with a second base station to define a configuration for a joint paging area for idle mode paging, inactive mode paging, or both, identify a UE within the joint paging area that is operating in an inactive mode or an idle mode, and transmit a joint paging message to the UE in accordance with the configuration. The communications manager 1015 may be an example of aspects of the communications manager 1310 described herein.

The communications manager 1015, or its sub-components, may be implemented in hardware, code (e.g., software or firmware) executed by a processor, or any combination thereof. If implemented in code executed by a processor, the functions of the communications manager 1015, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 1015, or its sub-components, may be physically located at various positions, including being distributed such that portions of functions are implemented at different physical locations by one or more physical components. In some examples, the communications manager 1015, or its sub-components, may be a separate and distinct component in accordance with various aspects of the present disclosure. In some examples, the communications manager 1015, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 1020 may transmit signals generated by other components of the device 1005. In some examples, the transmitter 1020 may be collocated with a receiver 1010 in a transceiver module. For example, the transmitter 1020 may be an example of aspects of the transceiver 1320 described with reference to FIG. 13. The transmitter 1020 may utilize a single antenna or a set of antennas.

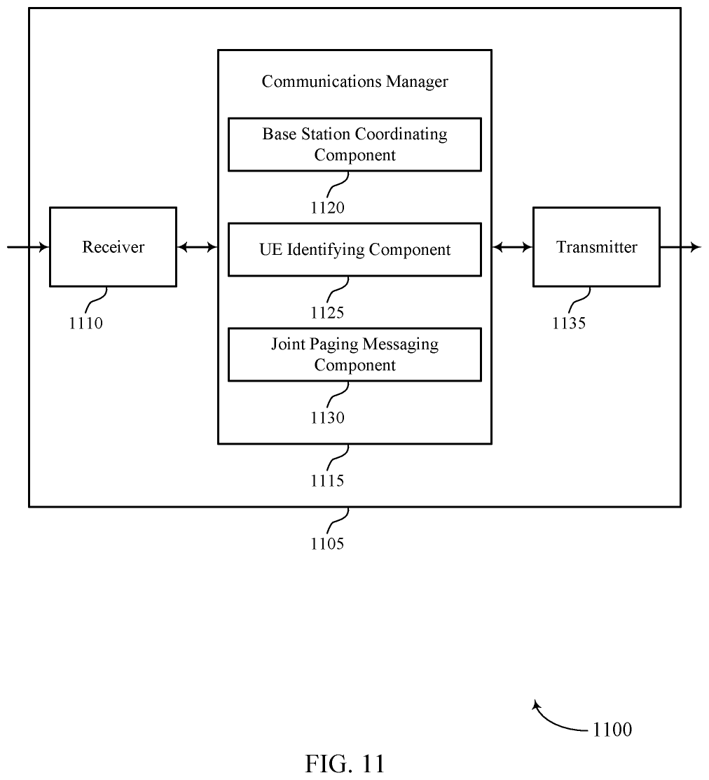

FIG. 11 shows a block diagram 1100 of a device 1105 that supports coordination and transmission of joint paging in accordance with aspects of the present disclosure. The device 1105 may be an example of aspects of a device 1005, or a base station 105 as described herein. The device 1105 may include a receiver 1110, a communications manager 1115, and a transmitter 1135. The device 1105 may also include a processor. Each of these components may be in communication with one another (e.g., via one or more buses).

The receiver 1110 may receive information such as packets, user data, or control information associated with various information channels (e.g., control channels, data channels, and information related to coordination and transmission of joint paging, etc.). Information may be passed on to other components of the device 1105. The receiver 1110 may be an example of aspects of the transceiver 1320 described with reference to FIG. 13. The receiver 1110 may utilize a single antenna or a set of antennas.

The communications manager 1115 may be an example of aspects of the communications manager 1015 as described herein. The communications manager 1115 may include a base station coordinating component 1120, an UE identifying component 1125, and a joint paging messaging component 1130. The communications manager 1115 may be an example of aspects of the communications manager 1310 described herein.

The base station coordinating component 1120 may coordinate with a second base station to define a configuration for a joint paging area for idle mode paging, inactive mode paging, or both. The UE identifying component 1125 may identify a UE within the joint paging area that is operating in an inactive mode or an idle mode. The joint paging messaging component 1130 may transmit a joint paging message to the UE in accordance with the configuration.

The transmitter 1135 may transmit signals generated by other components of the device 1105. In some examples, the transmitter 1135 may be collocated with a receiver 1110 in a transceiver module. For example, the transmitter 1135 may be an example of aspects of the transceiver 1320 described with reference to FIG. 13. The transmitter 1135 may utilize a single antenna or a set of antennas.

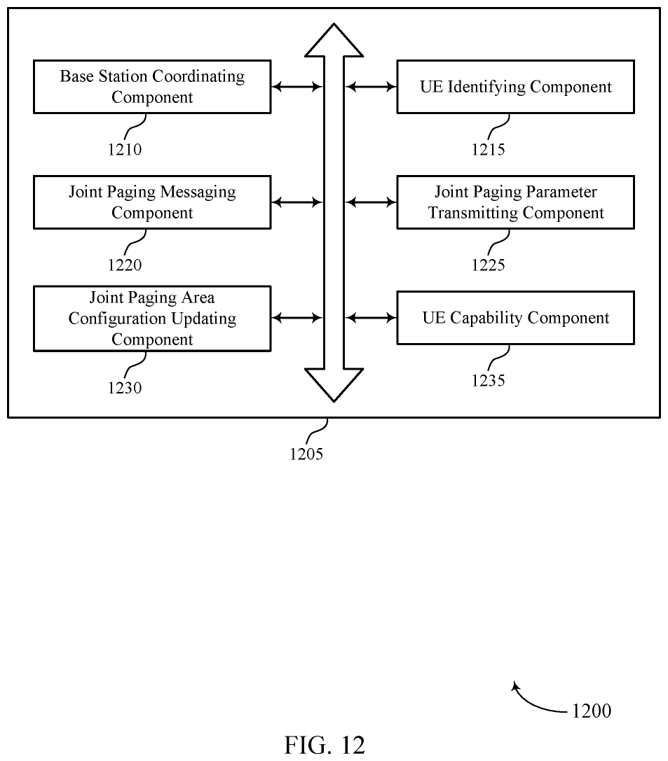

FIG. 12 shows a block diagram 1200 of a communications manager 1205 that supports coordination and transmission of joint paging in accordance with aspects of the present disclosure. The communications manager 1205 may be an example of aspects of a communications manager 1015, a communications manager 1115, or a communications manager 1310 described herein. The communications manager 1205 may include a base station coordinating component 1210, an UE identifying component 1215, a joint paging messaging component 1220, a joint paging parameter transmitting component 1225, a joint paging area configuration updating component 1230, and an UE capability component 1235. Each of these modules may communicate, directly or indirectly, with one another (e.g., via one or more buses).

The base station coordinating component 1210 may coordinate with a second base station to define a configuration for a joint paging area for idle mode paging, inactive mode paging, or both. In some examples, the base station coordinating component 1210 may exchange capability information, channel configuration, or both, with the second base station. In some examples, the base station coordinating component 1210 may indicate one or more joint paging parameters for the joint paging area. In some examples, the base station coordinating component 1210 may receive a suggested modification to at least one of the one or more joint paging parameters.

In some examples, the base station coordinating component 1210 may transmit the configuration to the second base station. In some examples, the base station coordinating component 1210 may coordinate with a third base station to define a second configuration for a second joint paging area for idle mode paging, inactive mode paging, or both. In some cases, the first base station belongs to a set of joint paging areas that includes the joint paging area. In some cases, a paging occasion of the joint paging area differs in time, frequency, or both, from a paging occasion of a second joint paging area of the set of joint paging areas. In some cases, the first base station is a primary base station and the second base station is a secondary base station. In some cases, the first base station is a secondary base station and the second base station is a primary base station.

The UE identifying component 1215 may identify a UE within the joint paging area that is operating in an inactive mode or an idle mode. The joint paging messaging component 1220 may transmit a joint paging message to the UE in accordance with the configuration. In some cases, the joint paging message indicates that the joint paging message is initiated from a core network or a radio access network.

The joint paging parameter transmitting component 1225 may transmit one or more joint paging parameters for the joint paging area that correspond to the configuration. In some examples, the joint paging parameter transmitting component 1225 may broadcast the one or more joint paging parameters. In some examples, transmitting, to the UE, a radio resource control reconfiguration message or a radio resource reconfiguration message that includes the one or more joint paging parameters. In some examples, the joint paging parameter transmitting component 1225 may broadcast one or more joint paging parameters for the second base station and an identifier for the second base station.

In some examples, the joint paging parameter transmitting component 1225 may transmit one or more joint paging parameters for the second joint paging area that correspond to the second configuration. In some cases, the one or more joint paging parameters include one or more of a default paging cycle, a number of paging occasions per cycle, an offset for a paging frame, one or more offsets for each paging occasion, a paging search space, one or more physical channel parameters, or any combination thereof. In some cases, the first and second base stations belong to the joint paging area and each use the one or more joint paging parameters for idle mode paging, inactive mode paging, or both.

The joint paging area configuration updating component 1230 may update the configuration for the joint paging area. In some examples, the joint paging area configuration updating component 1230 may transmit the updated configuration. In some examples, the joint paging area configuration updating component 1230 may update a cell barring parameter, a camping parameter, or both for a base station associated with the joint paging area. In some examples, the joint paging area configuration updating component 1230 may transmit an identifier of the base station associated with the joint paging area corresponding to the updated cell barring parameter, the updated camping parameter, or both. In some cases, the identifier is an index or a bitmap. The UE capability component 1235 may receive a capability message from the UE indicating a capability of the UE to receive joint paging, where the joint paging message is transmitted to the UE based on the capability message.

FIG. 13 shows a diagram of a system 1300 including a device 1305 that supports coordination and transmission of joint paging in accordance with aspects of the present disclosure. The device 1305 may be an example of or include the components of device 1005, device 1105, or a base station 105 as described herein. The device 1305 may include components for bi-directional voice and data communications including components for transmitting and receiving communications, including a communications manager 1310, a network communications manager 1315, a transceiver 1320, an antenna 1325, memory 1330, a processor 1340, and an inter-station communications manager 1345. These components may be in electronic communication via one or more buses (e.g., bus 1350).

The communications manager 1310 may coordinate with a second base station to define a configuration for a joint paging area for idle mode paging, inactive mode paging, or both, identify a UE within the joint paging area that is operating in an inactive mode or an idle mode, and transmit a joint paging message to the UE in accordance with the configuration.

The network communications manager 1315 may manage communications with the core network (e.g., via one or more wired backhaul links). For example, the network communications manager 1315 may manage the transfer of data communications for client devices, such as one or more UEs 115.

The transceiver 1320 may communicate bi-directionally, via one or more antennas, wired, or wireless links as described above. For example, the transceiver 1320 may represent a wireless transceiver and may communicate bi-directionally with another wireless transceiver. The transceiver 1320 may also include a modem to modulate the packets and provide the modulated packets to the antennas for transmission, and to demodulate packets received from the antennas.

In some cases, the wireless device may include a single antenna 1325. However, in some cases the device may have more than one antenna 1325, which may be capable of concurrently transmitting or receiving multiple wireless transmissions.

The memory 1330 may include RAM, ROM, or a combination thereof. The memory 1330 may store computer-readable code 1335 including instructions that, when executed by a processor (e.g., the processor 1340) cause the device to perform various functions described herein. In some cases, the memory 1330 may contain, among other things, a BIOS which may control basic hardware or software operation such as the interaction with peripheral components or devices.

The processor 1340 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some cases, a memory controller may be integrated into processor 1340. The processor 1340 may be configured to execute computer-readable instructions stored in a memory (e.g., the memory 1330) to cause the device 1305 to perform various functions (e.g., functions or tasks supporting coordination and transmission of joint paging).

The inter-station communications manager 1345 may manage communications with other base station 105 and may include a controller or scheduler for controlling communications with UEs 115 in cooperation with other base stations 105. For example, the inter-station communications manager 1345 may coordinate scheduling for transmissions to UEs 115 for various interference mitigation techniques such as beamforming or joint transmission. In some examples, the inter-station communications manager 1345 may provide an X2 interface within an LTE/LTE-A wireless communication network technology to provide communication between base stations 105.

The code 1335 may include instructions to implement aspects of the present disclosure, including instructions to support wireless communications. The code 1335 may be stored in a non-transitory computer-readable medium such as system memory or other type of memory. In some cases, the code 1335 may not be directly executable by the processor 1340 but may cause a computer (e.g., when compiled and executed) to perform functions described herein.

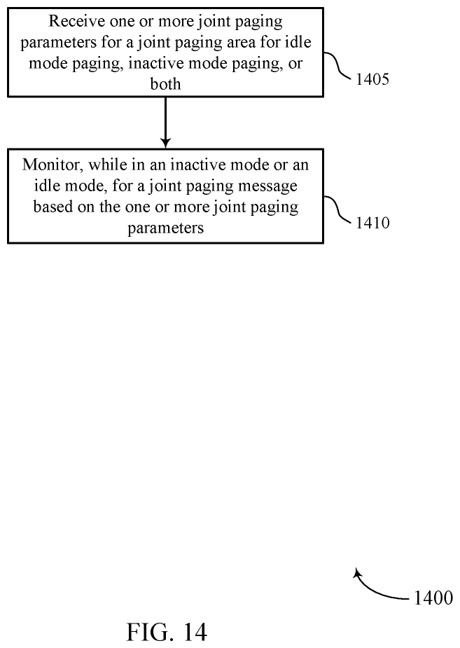

FIG. 14 shows a flowchart illustrating a method 1400 that supports coordination and transmission of joint paging in accordance with aspects of the present disclosure. The operations of method 1400 may be implemented by a UE 115 or its components as described herein. For example, the operations of method 1400 may be performed by a communications manager as described with reference to FIGS. 6 through 9. In some examples, a UE may execute a set of instructions to control the functional elements of the UE to perform the functions described below. Additionally or alternatively, a UE may perform aspects of the functions described below using special-purpose hardware.

At 1405, the UE may receive one or more joint paging parameters for a joint paging area for idle mode paging, inactive mode paging, or both. The operations of 1405 may be performed according to the methods described herein. In some examples, aspects of the operations of 1405 may be performed by a joint paging parameters receiving component as described with reference to FIGS. 6 through 9.

At 1410, the UE may monitor, while in an inactive mode or an idle mode, for a joint paging message based on the one or more joint paging parameters. The operations of 1410 may be performed according to the methods described herein. In some examples, aspects of the operations of 1410 may be performed by a joint paging message monitoring component as described with reference to FIGS. 6 through 9.

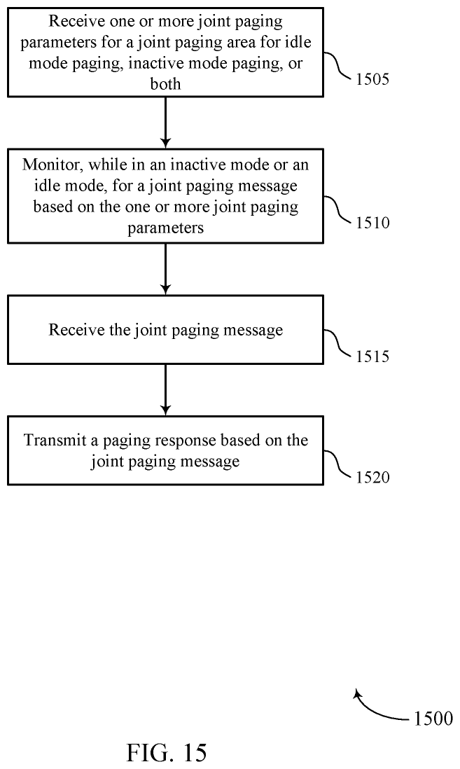

FIG. 15 shows a flowchart illustrating a method 1500 that supports coordination and transmission of joint paging in accordance with aspects of the present disclosure. The operations of method 1500 may be implemented by a UE 115 or its components as described herein. For example, the operations of method 1500 may be performed by a communications manager as described with reference to FIGS. 6 through 9. In some examples, a UE may execute a set of instructions to control the functional elements of the UE to perform the functions described below. Additionally or alternatively, a UE may perform aspects of the functions described below using special-purpose hardware.

At 1505, the UE may receive one or more joint paging parameters for a joint paging area for idle mode paging, inactive mode paging, or both. The operations of 1505 may be performed according to the methods described herein. In some examples, aspects of the operations of 1505 may be performed by a joint paging parameters receiving component as described with reference to FIGS. 6 through 9.

At 1510, the UE may monitor, while in an inactive mode or an idle mode, for a joint paging message based on the one or more joint paging parameters. The operations of 1510 may be performed according to the methods described herein. In some examples, aspects of the operations of 1510 may be performed by a joint paging message monitoring component as described with reference to FIGS. 6 through 9.

At 1515, the UE may receive the joint paging message. The operations of 1515 may be performed according to the methods described herein. In some examples, aspects of the operations of 1515 may be performed by a joint paging parameters receiving component as described with reference to FIGS. 6 through 9.

At 1520, the UE may transmit a paging response based on the joint paging message. The operations of 1520 may be performed according to the methods described herein. In some examples, aspects of the operations of 1520 may be performed by a paging response component as described with reference to FIGS. 6 through 9.

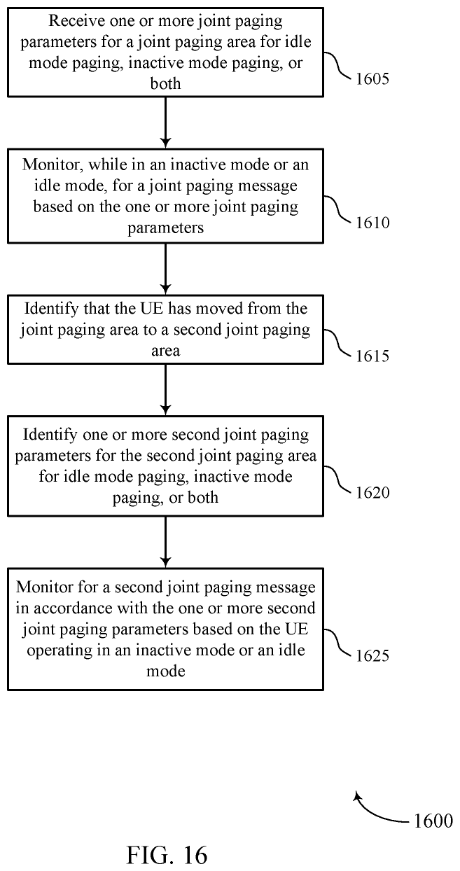

FIG. 16 shows a flowchart illustrating a method 1600 that supports coordination and transmission of joint paging in accordance with aspects of the present disclosure. The operations of method 1600 may be implemented by a UE 115 or its components as described herein. For example, the operations of method 1600 may be performed by a communications manager as described with reference to FIGS. 6 through 9. In some examples, a UE may execute a set of instructions to control the functional elements of the UE to perform the functions described below. Additionally or alternatively, a UE may perform aspects of the functions described below using special-purpose hardware.

At 1605, the UE may receive one or more joint paging parameters for a joint paging area for idle mode paging, inactive mode paging, or both. The operations of 1605 may be performed according to the methods described herein. In some examples, aspects of the operations of 1605 may be performed by a joint paging parameters receiving component as described with reference to FIGS. 6 through 9.

At 1610, the UE may monitor, while in an inactive mode or an idle mode, for a joint paging message based on the one or more joint paging parameters. The operations of 1610 may be performed according to the methods described herein. In some examples, aspects of the operations of 1610 may be performed by a joint paging message monitoring component as described with reference to FIGS. 6 through 9.

At 1615, the UE may identify that the UE has moved from the joint paging area to a second joint paging area. The operations of 1615 may be performed according to the methods described herein. In some examples, aspects of the operations of 1615 may be performed by an UE mobility component as described with reference to FIGS. 6 through 9.

At 1620, the UE may identify one or more second joint paging parameters for the second joint paging area for idle mode paging, inactive mode paging, or both. The operations of 1620 may be performed according to the methods described herein. In some examples, aspects of the operations of 1620 may be performed by an UE mobility component as described with reference to FIGS. 6 through 9.

At 1625, the UE may monitor for a second joint paging message in accordance with the one or more second joint paging parameters based on the UE operating in an inactive mode or an idle mode. The operations of 1625 may be performed according to the methods described herein. In some examples, aspects of the operations of 1625 may be performed by an UE mobility component as described with reference to FIGS. 6 through 9.

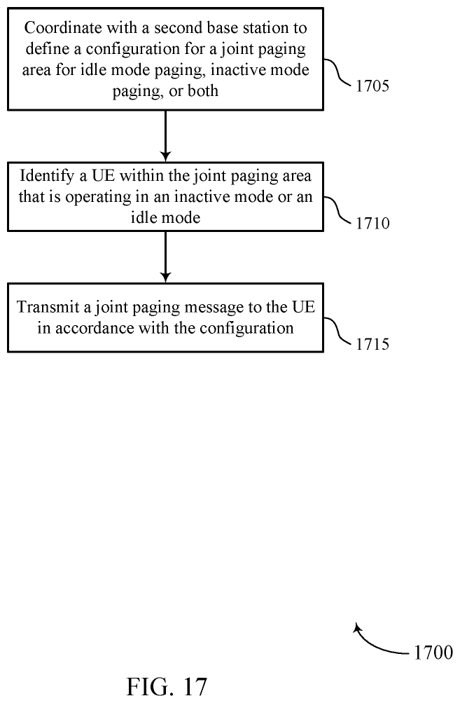

FIG. 17 shows a flowchart illustrating a method 1700 that supports coordination and transmission of joint paging in accordance with aspects of the present disclosure. The operations of method 1700 may be implemented by a base station 105 or its components as described herein. For example, the operations of method 1700 may be performed by a communications manager as described with reference to FIGS. 10 through 13. In some examples, a base station may execute a set of instructions to control the functional elements of the base station to perform the functions described below. Additionally or alternatively, a base station may perform aspects of the functions described below using special-purpose hardware.

At 1705, the base station may coordinate with a second base station to define a configuration for a joint paging area for idle mode paging, inactive mode paging, or both. The operations of 1705 may be performed according to the methods described herein. In some examples, aspects of the operations of 1705 may be performed by a base station coordinating component as described with reference to FIGS. 10 through 13.

At 1710, the base station may identify a UE within the joint paging area that is operating in an inactive mode or an idle mode. The operations of 1710 may be performed according to the methods described herein. In some examples, aspects of the operations of 1710 may be performed by an UE identifying component as described with reference to FIGS. 10 through 13.

At 1715, the base station may transmit a joint paging message to the UE in accordance with the configuration. The operations of 1715 may be performed according to the methods described herein. In some examples, aspects of the operations of 1715 may be performed by a joint paging messaging component as described with reference to FIGS. 10 through 13.

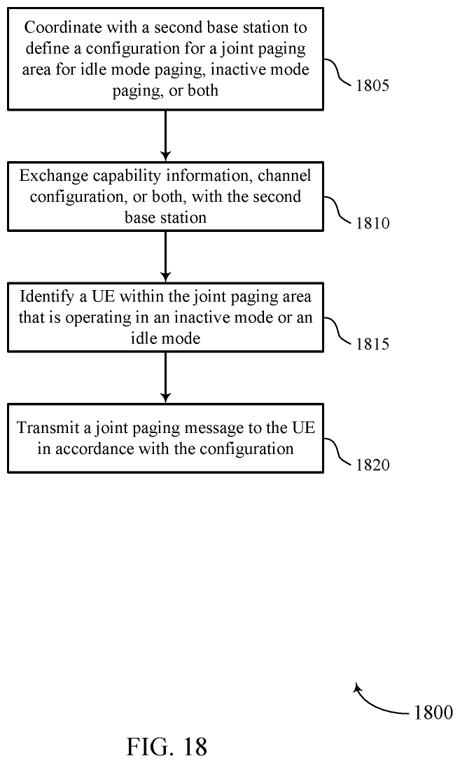

FIG. 18 shows a flowchart illustrating a method 1800 that supports coordination and transmission of joint paging in accordance with aspects of the present disclosure. The operations of method 1800 may be implemented by a base station 105 or its components as described herein. For example, the operations of method 1800 may be performed by a communications manager as described with reference to FIGS. 10 through 13. In some examples, a base station may execute a set of instructions to control the functional elements of the base station to perform the functions described below. Additionally or alternatively, a base station may perform aspects of the functions described below using special-purpose hardware.

At 1805, the base station may coordinate with a second base station to define a configuration for a joint paging area for idle mode paging, inactive mode paging, or both. The operations of 1805 may be performed according to the methods described herein. In some examples, aspects of the operations of 1805 may be performed by a base station coordinating component as described with reference to FIGS. 10 through 13.

At 1810, the base station may exchange capability information, channel configuration, or both, with the second base station. The operations of 1810 may be performed according to the methods described herein. In some examples, aspects of the operations of 1810 may be performed by a base station coordinating component as described with reference to FIGS. 10 through 13.

At 1815, the base station may identify a UE within the joint paging area that is operating in an inactive mode or an idle mode. The operations of 1815 may be performed according to the methods described herein. In some examples, aspects of the operations of 1815 may be performed by an UE identifying component as described with reference to FIGS. 10 through 13.

At 1820, the base station may transmit a joint paging message to the UE in accordance with the configuration. The operations of 1820 may be performed according to the methods described herein. In some examples, aspects of the operations of 1820 may be performed by a joint paging messaging component as described with reference to FIGS. 10 through 13.

It should be noted that the methods described herein describe possible implementations, and that the operations and the steps may be rearranged or otherwise modified and that other implementations are possible. Further, aspects from two or more of the methods may be combined.

### Embodiment 1

A method for wireless communication by a user equipment (UE), comprising: receiving one or more joint paging parameters for a joint paging area for idle mode paging, inactive mode paging, or both; and monitoring, while in an inactive mode or an idle mode, for a joint paging message based at least in part on the one or more joint paging parameters.

### Embodiment 2

The method of embodiment 1, wherein receiving the one or more joint paging parameters for the joint paging area further comprises: receiving a radio resource control reconfiguration message or a radio resource release message that comprises the one or more joint paging parameters.

### Embodiment 3

The method of any of embodiments 1 to 2, wherein the one or more joint paging parameters comprise one or more of a default paging cycle, a number of paging occasions per cycle, an offset for a paging frame, one or more offsets for each paging occasion, a paging search space, one or more physical channel parameters, or any combination thereof.

### Embodiment 4

The method of any of embodiments 1 to 3, wherein monitoring for the joint paging message further comprises: receiving the joint paging message; and transmitting a paging response based at least in part on the joint paging message.

### Embodiment 5

The method of any of embodiments 1 to 4, further comprising: receiving an update to one or more of the one or more joint paging parameters; and monitoring for the joint paging message in accordance with the updated one or more joint paging parameters.

### Embodiment 6

The method of embodiment 5, wherein the updated one or more joint paging parameters are an update to a cell barring parameter, a camping parameter, or both for a base station associated with the joint paging area.

### Embodiment 7

The method of embodiment 6, further comprising: receiving an identifier of the base station associated with the joint paging area having the updated one or more joint paging parameters.

### Embodiment 8

The method of embodiment 7, wherein the identifier is an index or a bitmap.

### Embodiment 9

The method of any of embodiments 1 to 8, further comprising: identifying that the UE has moved from the joint paging area to a second joint paging area; identifying one or more second joint paging parameters for the second joint paging area for idle mode paging, inactive mode paging, or both; and monitoring for a second joint paging message in accordance with the one or more second joint paging parameters based at least in part on the UE operating in an inactive mode or an idle mode.

### Embodiment 10

The method of any of embodiments 1 to 9, further comprising: receiving one or more joint paging parameters for a second joint paging area that differs from the joint paging area; and monitoring for a second joint paging message based at least in part on the one or more joint paging parameters for the second joint paging area.

### Embodiment 11

The method of any of embodiments 1 to 10, further comprising: transmitting a capability message indicating a capability of the UE to receive joint paging; and receiving the joint paging message based at least in part on the capability message.

### Embodiment 12

The method of embodiment 11, wherein the joint paging message indicates that the joint paging message is initiated from a core network or a radio access network.

### Embodiment 13

The method of any of embodiments 1 to 12, wherein monitoring for the joint paging message further comprises: monitoring for the joint paging message from a first base station and a second base station, wherein the first base station is a primary base station and the second base station is a secondary base station.

### Embodiment 14

The method of any of embodiments 1 to 13, wherein monitoring for the joint paging message further comprises: monitoring for the joint paging message from a first base station and a second base station, wherein the first base station is a secondary base station and the second base station is a primary base station.

### Embodiment 15

The method of any of embodiments 1 to 14, wherein monitoring for the joint paging message further comprises: determining a paging frame and a paging occasion based at least in part on the one or more joint paging parameters; and monitoring for the joint paging message based at least in part on the paging frame and the paging occasion.

### Embodiment 16

A method for wireless communication by a first base station, comprising: coordinating with a second base station to define a configuration for a joint paging area for idle mode paging, inactive mode paging, or both; identifying a user equipment (UE) within the joint paging area that is operating in an inactive mode or an idle mode; and transmitting a joint paging message to the UE in accordance with the configuration.

### Embodiment 17

The method of embodiment 16, wherein coordinating with the second base station to define the configuration further comprises: exchanging capability information, channel configuration, or both, with the second base station.

### Embodiment 18

The method of any of embodiments 16 to 17, wherein coordinating with the second base station to define the configuration further comprises: indicating one or more joint paging parameters for the joint paging area.

### Embodiment 19

The method of embodiment 18, wherein coordinating with the second base station to define the configuration further comprises: receiving a suggested modification to at least one of the one or more joint paging parameters.

### Embodiment 20

The method of embodiment 18, wherein coordinating with the second base station to define the configuration further comprises: transmitting the configuration to the second base station.

### Embodiment 21

The method of any of embodiments 16 to 20, wherein the first base station belongs to a plurality of joint paging areas that includes the joint paging area.

### Embodiment 22

The method of embodiment 21, wherein a paging occasion of the joint paging area differs in time, frequency, or both, from a paging occasion of a second joint paging area of the plurality of joint paging areas.

### Embodiment 23

The method of any of embodiments 16 to 22, further comprising: transmitting one or more joint paging parameters for the joint paging area that correspond to the configuration.

### Embodiment 24

The method of embodiment 23, wherein transmitting the one or more joint paging parameters further comprises: broadcasting the one or more joint paging parameters.

### Embodiment 25

The method of embodiment 23, wherein transmitting the one or more joint paging parameters further comprises: transmitting, to the UE, a radio resource control release message or a radio resource reconfiguration message that comprises the one or more joint paging parameters.

### Embodiment 26

The method of embodiment 23, wherein the one or more joint paging parameters comprise one or more of a default paging cycle, a number of paging occasions per cycle, an offset for a paging frame, one or more offsets for each paging occasion, a paging search space, one or more physical channel parameters, or any combination thereof.

### Embodiment 27

The method of embodiment 23, wherein the first and second base stations belong to the joint paging area and each use the one or more joint paging parameters for idle mode paging, inactive mode paging, or both.

### Embodiment 28

The method of any of embodiments 16 to 27, further comprising: broadcasting one or more joint paging parameters for the second base station and an identifier for the second base station.

### Embodiment 29

The method of any of embodiments 16 to 28, further comprising: updating the configuration for the joint paging area; and transmitting the updated configuration.

### Embodiment 30

The method of embodiment 29, wherein updating the configuration further comprises: updating a cell barring parameter, a camping parameter, or both for a base station associated with the joint paging area.

### Embodiment 31

The method of embodiment 30, wherein transmitting the updated configuration comprises: transmitting an identifier of the base station associated with the joint paging area corresponding to the updated cell barring parameter, the updated camping parameter, or both.

### Embodiment 32

The method of embodiment 31, wherein the identifier is an index or a bitmap.

### Embodiment 33

The method of any of embodiments 16 to 32, further comprising: coordinating with a third base station to define a second configuration for a second joint paging area for idle mode paging, inactive mode paging, or both; and transmitting one or more joint paging parameters for the second joint paging area that correspond to the second configuration.

### Embodiment 34

The method of any of embodiments 16 to 33, further comprising: receiving a capability message from the UE indicating a capability of the UE to receive joint paging, wherein the joint paging message is transmitted to the UE based at least in part on the capability message.

### Embodiment 35

The method of any of embodiments 16 to 34, wherein the joint paging message indicates that the joint paging message is initiated from a core network or a radio access network.

### Embodiment 36

The method of any of embodiments 16 to 35, wherein the first base station is a primary base station and the second base station is a secondary base station.

### Embodiment 37

The method of any of embodiments 16 to 36, wherein the first base station is a secondary base station and the second base station is a primary base station.

### Embodiment 38

An apparatus comprising at least one means for performing a method of any of embodiments 1 to 15.

### Embodiment 39

An apparatus for wireless communications comprising a processor; memory in electronic communication with the processor; and instructions stored in the memory and executable by the processor to cause the apparatus to perform a method of any of embodiments 1 to 15.

### Embodiment 40

A non-transitory computer-readable medium storing code for wireless communications, the code comprising instructions executable by a processor to perform a method of any of embodiments 1 to 15.

### Embodiment 41

An apparatus comprising at least one means for performing a method of any of embodiments 16 to 38.

### Embodiment 42

An apparatus for wireless communications comprising a processor; memory in electronic communication with the processor; and instructions stored in the memory and executable by the processor to cause the apparatus to perform a method of any of embodiments 16 to 38.

### Embodiment 43

A non-transitory computer-readable medium storing code for wireless communications, the code comprising instructions executable by a processor to perform a method of any of embodiments 16 to 38.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM).

An OFDMA system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications System (UMTS). LTE, LTE-A, and LTE-A Pro are releases of UMTS that use E-UTRA. UTRA, E-UTRA, UMTS, LTE, LTE-A, LTE-A Pro, NR, and GSM are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned herein as well as other systems and radio technologies. While aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR applications.

A macro cell generally covers a relatively large geographic area (e.g., several kilometers in radius) and may allow unrestricted access by UEs with service subscriptions with the network provider. A small cell may be associated with a lower-powered base station, as compared with a macro cell, and a small cell may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells, and may also support communications using one or multiple component carriers.

The wireless communications systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication by a user equipment (UE), comprising:
receiving one or more joint paging parameters for a joint paging area for idle mode paging, inactive mode paging, or both; and
monitoring, while in an inactive mode or an idle mode, for a joint paging message based at least in part on the one or more joint paging parameters.

2. The method of claim 1, wherein receiving the one or more joint paging parameters for the joint paging area further comprises:
receiving a radio resource control reconfiguration message or a radio resource release message that comprises the one or more joint paging parameters.

3. The method of claim 1, wherein the one or more joint paging parameters comprise one or more of a default paging cycle, a number of paging occasions per cycle, an offset for a paging frame, one or more offsets for each paging occasion, a paging search space, one or more physical channel parameters, or any combination thereof.

4. The method of claim 1, further comprising:
receiving an update to one or more of the one or more joint paging parameters; and
monitoring for the joint paging message in accordance with the updated one or more joint paging parameters.

5. The method of claim 4, wherein the updated one or more joint paging parameters are an update to a cell barring parameter, a camping parameter, or both for a base station associated with the joint paging area.

6. The method of claim 5, further comprising:
receiving an identifier of the base station associated with the joint paging area having the updated one or more joint paging parameters.

7. The method of claim 6, wherein the identifier is an index or a bitmap.

8. The method of claim 1, further comprising:
identifying that the UE has moved from the joint paging area to a second joint paging area;
identifying one or more second joint paging parameters for the second joint paging area for idle mode paging, inactive mode paging, or both; and
monitoring for a second joint paging message in accordance with the one or more second joint paging parameters based at least in part on the UE operating in an inactive mode or an idle mode.

9. The method of claim 1, further comprising:
receiving one or more joint paging parameters for a second joint paging area that differs from the joint paging area; and
monitoring for a second joint paging message based at least in part on the one or more joint paging parameters for the second joint paging area.

10. The method of claim 1, further comprising:
transmitting a capability message indicating a capability of the UE to receive joint paging; and
receiving the joint paging message based at least in part on the capability message.

11. The method of claim 10, wherein the joint paging message indicates that the joint paging message is initiated from a core network or a radio access network.

12. The method of claim 1, wherein monitoring for the joint paging message further comprises:
monitoring for the joint paging message from a first base station and a second base station, wherein the first base station is a primary base station and the second base station is a secondary base station.

13. The method of claim 1, wherein monitoring for the joint paging message further comprises:
determining a paging frame and a paging occasion based at least in part on the one or more joint paging parameters; and
monitoring for the joint paging message based at least in part on the paging frame and the paging occasion.

14. A method for wireless communication by a first base station, comprising:
coordinating with a second base station to define a configuration for a joint paging area for idle mode paging, inactive mode paging, or both;
identifying a user equipment (UE) within the joint paging area that is operating in an inactive mode or an idle mode; and
transmitting a joint paging message to the UE in accordance with the configuration.

15. The method of claim 14, wherein coordinating with the second base station to define the configuration further comprises:
exchanging capability information, channel configuration, or both, with the second base station.

16. The method of claim 14, wherein coordinating with the second base station to define the configuration further comprises:
indicating one or more joint paging parameters for the joint paging area, receiving a suggested modification to at least one of the one or more joint paging parameters, transmitting the configuration to the second base station, or any combination thereof.

17. The method of claim 14, wherein the first base station belongs to a plurality of joint paging areas that includes the joint paging area.

18. The method of claim 17, wherein a paging occasion of the joint paging area differs in time, frequency, or both, from a paging occasion of a second joint paging area of the plurality of joint paging areas.

19. The method of claim 18, further comprising:
broadcasting one or more joint paging parameters for the second base station and an identifier for the second base station.

20. The method of claim 14, further comprising:
updating the configuration for the joint paging area; and
transmitting the updated configuration.

21. The method of claim 20, wherein updating the configuration further comprises:
updating a cell barring parameter, a camping parameter, or both for a base station associated with the joint paging area.

22. The method of claim 21, wherein transmitting the updated configuration comprises:
transmitting an identifier of the base station associated with the joint paging area corresponding to the updated cell barring parameter, the updated camping parameter, or both.

23. The method of claim 22, wherein the identifier is an index or a bitmap.

24. The method of claim 14, further comprising:
coordinating with a third base station to define a second configuration for a second joint paging area for idle mode paging, inactive mode paging, or both; and
transmitting one or more joint paging parameters for the second joint paging area that correspond to the second configuration.

25. The method of claim 14, further comprising:
receiving a capability message from the UE indicating a capability of the UE to receive joint paging, wherein the joint paging message is transmitted to the UE based at least in part on the capability message.

26. The method of claim 14, wherein the joint paging message indicates that the joint paging message is initiated from a core network or a radio access network.

27. The method of claim 14, wherein the first base station is a primary base station and the second base station is a secondary base station.

28. The method of claim 14, wherein the first base station is a secondary base station and the second base station is a primary base station.

29. An apparatus for wireless communication by a user equipment (UE), comprising:
a processor,
memory in electronic communication with the processor; and
instructions stored in the memory and executable by the processor to cause the apparatus to:
receive one or more joint paging parameters for a joint paging area for idle mode paging, inactive mode paging, or both; and
monitor, while in an inactive mode or an idle mode, for a joint paging message based at least in part on the one or more joint paging parameters.

30. An apparatus for wireless communication by a first base station, comprising:
a processor,
memory in electronic communication with the processor; and
instructions stored in the memory and executable by the processor to cause the apparatus to:
coordinate with a second base station to define a configuration for a joint paging area for idle mode paging, inactive mode paging, or both;
identify a user equipment (UE) within the joint paging area that is operating in an inactive mode or an idle mode; and
transmit a joint paging message to the UE in accordance with the configuration.
